(19) United States
(12) Patent Application Publication
(10) Pub. No.: US 2025/0251180 A1
(43) Pub. Date: Aug. 7, 2025

(54) HEAT PUMP CYCLE DEVICE

(71) Applicant: DENSO CORPORATION, Kariya-city (JP)

(72) Inventors: Yuichi KAMI, Kariya-city (JP); Atsushi Inaba, Kariya-city (JP); Daiki Kato, Kariya-city (JP); Hiroyuki Kobayashi, Kariya-city (JP)

(21) Appl. No.: 19/185,939

(22) Filed: Apr. 22, 2025

Related U.S. Application Data
(63) Continuation of application No. PCT/JP2023/036969, filed on Oct. 12, 2023.

(30) Foreign Application Priority Data
Nov. 9, 2022 (JP) 2022-179483

(51) Int. Cl. F25B 49/02; F25B 30/02; F25B 41/20

(52) U.S. Cl. CPC F25B 49/02; F25B 30/02; F25B 41/20; F25B 2400/0409

(57) ABSTRACT

A heat pump cycle device includes a compressor, a branching portion, a heating unit, a first decompression valve, a bypass passage, a second decompression valve, a joining portion, a heat generating unit, and a heat exchanger. The heating unit is configured to heat an object to be heated using the refrigerant flowing out of one outflow port of the branching portion as a heat source. An another refrigerant branched at the branching portion flows into the bypass passage. The heat exchanger is configured to cause at least the refrigerant flowing out of the first decompression valve to absorb heat generated by the heat generating unit.

### CROSS REFERENCE TO RELATED APPLICATION

The present application is a continuation application of International Patent Application No. PCT/JP2023/036969 filed on Oct. 12, 2023, which designated the U.S. and claims the benefit of priority from Japanese Patent Application No. 2022-179483 filed on Nov. 9, 2022. The entire disclosures of all of the above applications are incorporated herein by reference.

### TECHNICAL FIELD

The present disclosure relates to a heat pump cycle device that heats an object to be heated by using heat generated by compression work of a compressor.

### BACKGROUND

In a heat pump cycle device that is applied to a vehicle air conditioner and performs air-heating in a vehicle compartment, the operation in a hot gas air-heating mode can be performed by switching a refrigerant circuit under an operation condition in which it is difficult to absorb heat for heating ventilation air blown into the vehicle compartment from outside air, such as at a low outside air temperature.

### SUMMARY

According to an aspect of the present disclosure, a heat pump cycle device includes: a compressor configured to compress and discharge a refrigerant; a branching portion configured to branch a flow of the refrigerant discharged from the compressor; a heating unit configured to heat an object to be heated using the refrigerant flowing out of one outflow port of the branching portion as a heat source; a first decompression valve configured to decompress the refrigerant flowing out of the heating unit; a bypass passage through which an another refrigerant branched at the branching portion flows; a second decompression valve configured to decompress and regulate a flow rate of the refrigerant flowing through the bypass passage; a joining portion configured to join a flow of the refrigerant flowing out of the second decompression valve and a flow of the refrigerant flowing out of the first decompression valve and to cause a joined flow of the refrigerant to flow into a suction port side of the compressor; and a heat generating unit configured to generate heat.

For example, the heat pump cycle device may be provided with a heat medium circuit in which a heat medium heated by the heat generating unit circulates, and a heat exchanger that exchanges heat between the heat medium and the refrigerant to cause at least the refrigerant flowing out of the first decompression valve to absorb heat generated by the heat generating unit. In this case, the heat medium circuit may be configured to cause the heat medium to flow into the heat exchanger when an inflow temperature of the heat medium flowing into the heat exchanger is equal to or higher than a target heat medium temperature.

Alternatively, the heat pump cycle device may be provided with a heat exchanger configured to cause at least the refrigerant flowing out of the first decompression unit to absorb heat generated by the heat generating unit, and a controller including at least one of a circuit and a processor having a memory storing computer program code. In this case, the controller including the at least one of the circuit and the processor having the memory may be configured to: determine an upper limit rotation speed of the compressor; and control an amount of heat generated by the heat generating unit to cause a total amount of heat generated by the heat generating unit to be increased as the upper limit rotation speed decreases.

### BRIEF DESCRIPTION OF DRAWINGS

The above object and other objects, features, and advantages of the present disclosure will become more apparent from the following detailed description with reference to the accompanying drawings. In the drawings:

FIG. 1 is a schematic overall configuration diagram of a vehicle air conditioner of a first embodiment;

FIG. 2 is a schematic configuration diagram of an indoor air conditioning unit of the first embodiment;

FIG. 3 is a block diagram illustrating an electric control unit of the vehicle air conditioner of the first embodiment;

FIG. 4 is a control characteristic diagram for determining the upper limit rotation speed of a compressor for a vehicle speed in the first embodiment;

FIG. 5 is a control characteristic diagram for determining a target heat medium temperature for the upper limit rotation speed of the compressor in the first embodiment;

FIG. 6 is a schematic overall configuration diagram illustrating a flow of a refrigerant or the like in a first endothermic hot gas air-heating mode of the vehicle air conditioner of the first embodiment;

FIG. 7 is a Mollier chart showing a state of the refrigerant in the first endothermic hot gas air-heating mode in a heat pump cycle of the first embodiment;

FIG. 8 is a schematic overall configuration diagram illustrating a flow of the refrigerant or the like in a second endothermic hot gas air-heating mode of the vehicle air conditioner of the first embodiment;

FIG. 9 is a schematic overall configuration diagram illustrating a flow of the refrigerant or the like in a first endothermic hot gas air-heating preparing mode of the vehicle air conditioner of the first embodiment;

FIG. 10 is a schematic overall configuration diagram illustrating a flow of the refrigerant or the like in a second endothermic hot gas air-heating preparing mode of the vehicle air conditioner of the first embodiment;

FIG. 11 is a schematic overall configuration diagram of a vehicle air conditioner according to a second embodiment;

FIG. 12 is a schematic overall configuration diagram of a vehicle air conditioner according to a third embodiment; and

FIG. 13 is a schematic overall configuration diagram of a vehicle air conditioner according to a fourth embodiment.

### DESCRIPTION OF EMBODIMENTS

In a comparative heat pump cycle device applied to a vehicle air conditioner, a hot gas air-heating mode can be performed by switching a refrigerant circuit. In a refrigerant circuit of the hot gas air-heating mode, the flow of refrigerant discharged from a compressor is branched, and one branched refrigerant flows into a heating unit. The heating unit heats ventilation air using the refrigerant discharged from the compressor as a heat source. In the refrigerant circuit of the hot gas air-heating mode, the refrigerant flowing out of the heating unit and the other refrigerant branched at the branching portion are decompressed and then mixed to be drawn into the compressor.

As a result, in the comparative heat pump cycle device, the ventilation air as the object to be heated is heated using heat generated by the compression work of the compressor without using heat absorbed from the outside air in the hot gas air-heating mode.

However, in the hot gas air-heating mode, ventilation air is heated using only heat generated by the compression work of the compressor. In this case, when the rotation speed of the compressor reaches the upper limit rotation speed determined from the durability of the compressor, the noise allowed for the compressor, and the like, the ventilation air heating capability in the heating unit cannot be effectively improved. As a result, the heating capability of the heating unit may be insufficient.

In view of the above, it is an object of the present disclosure to provide a heat pump cycle device, which is possible to improve a heating capability of an object to be heated without increasing a rotation speed of a compressor.

A heat pump cycle device according to an aspect of the present disclosure includes a compressor, a branching portion, a heating unit, a heating-unit side decompression unit, a bypass passage, a bypass-side flow rate regulating unit, a joining portion, a heat generating unit, and an endothermic unit.

The compressor is configured to compress and discharge a refrigerant. The branching portion is configured to branch a flow of the refrigerant discharged from the compressor. The heating unit is configured to heat an object to be heated using the refrigerant flowing out of one outflow port of the branching portion as a heat source. The heating-unit side decompression unit is configured to decompress the refrigerant flowing out of the heating unit. The bypass passage is made to cause an another refrigerant branched at the branching portion flows therethrough. The bypass-side flow rate regulating unit is configured to regulate a flow rate of the refrigerant flowing through the bypass passage. The joining portion is configured to join a flow of the refrigerant flowing out of the bypass-side flow rate regulating unit and a flow of the refrigerant flowing out of the heating-unit side decompression unit, and to cause a joined flow of the refrigerant to flow into a suction port side of the compressor. The heat generating unit is configured to generate heat. The endothermic unit is configured to cause at least the refrigerant flowing out of the heating-unit side decompression unit to absorb heat generated by the heat generating unit.

Accordingly, the heating unit can heat the object to be heated. At this time, refrigerant with relatively high enthalpy flowing out of the bypass-side flow rate regulating unit and refrigerant with relatively low enthalpy flowing out of the heating-unit side decompression unit are joined at the joining portion, and the joined refrigerant flows to the suction port side of the compressor. Therefore, a suction refrigerant drawn into the compressor can be maintained in an appropriate state, and the heating unit can stably heat the object to be heated.

The endothermic unit causes at least the refrigerant flowing out of the heating-unit side decompression unit to absorb the heat generated by the heat generating unit. Therefore, by increasing the amount of heat absorbed by the refrigerant flowing out of the heating-unit side decompression unit, the amount of heat radiated from the refrigerant to the object to be heated in the heating unit can be increased without increasing the rotation speed of the compressor.

Thus, according to the heat pump cycle device of one aspect of the present disclosure, it is possible to improve the heating capability of the heating unit, to heat the object to be heated, without increasing the rotation speed of the compressor.

Here, “at least the refrigerant flowing out of the heating-unit side decompression unit” is not limited to only the refrigerant flowing out of the heating-unit side decompression unit. As long as the refrigerant flowing out of the heating-unit side decompression unit is included, the refrigerant may be a refrigerant that has joined with the refrigerant flowing out of the bypass-side flow rate regulating unit.

Hereinafter, a plurality of embodiments for carrying out the present disclosure will be described with reference to the drawings. In each embodiment, parts corresponding to matters described in the preceding embodiment are denoted by the same reference numerals, and redundant description may be omitted. In a case where only a part of a configuration is described in each embodiment, other embodiments already described can be applied to other parts of the configuration. It is possible to combine the parts explicitly described that the parts can be combined in each embodiment. Furthermore, the embodiments can be partially combined even if it is not explicitly described that the embodiments can be combined, provided there is no particular problem in the combination.

### First Embodiment

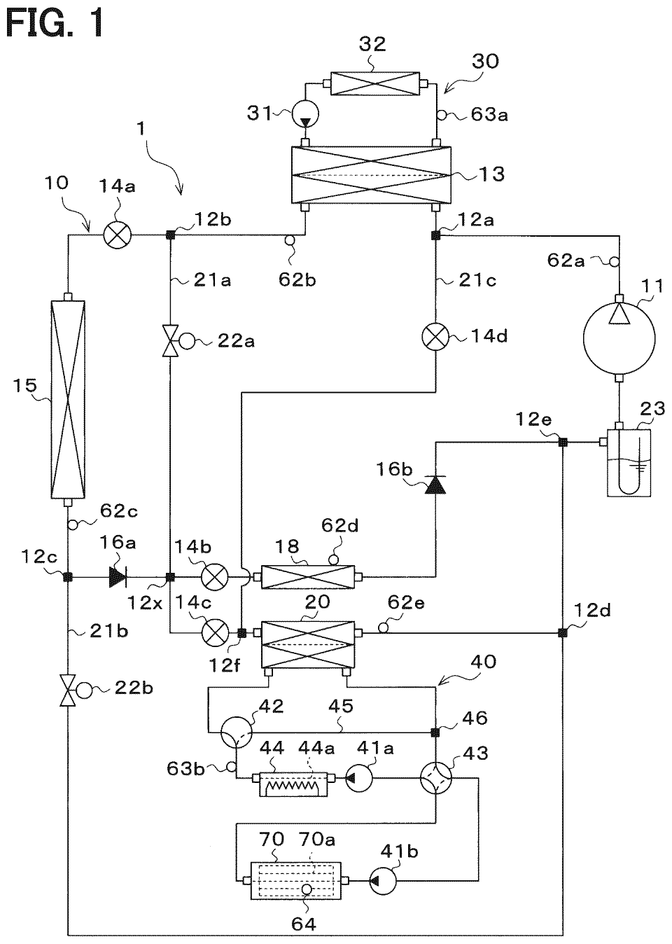

A first embodiment of a heat pump cycle device according to the present disclosure will be described with reference to FIGS. 1 to 10. In the present embodiment, the heat pump cycle device according to the present disclosure is applied to a vehicle air conditioner 1 mounted on an electric vehicle. The electric vehicle is a vehicle that obtains traveling drive force from an electric motor. The vehicle air conditioner 1 performs air conditioning in a vehicle compartment, which is a space to be air conditioned, and adjusts the temperature of an in-vehicle device. Therefore, the vehicle air conditioner 1 can be referred to as an air conditioner with an in-vehicle device temperature adjustment function or an in-vehicle device temperature adjustment device with an air conditioning function.

The vehicle air conditioner 1 specifically adjusts the temperature of a battery 70 as the in-vehicle device. The battery 70 is a secondary battery that stores electric power supplied to a plurality of in-vehicle devices operated by electricity. The battery 70 is an assembled battery formed by electrically connecting a plurality of stacked battery cells in series or in parallel. The battery cell of the present embodiment is a lithium ion battery.

The battery 70 generates heat during operation (that is, at the time of charging and discharging). The output of the battery 70 is likely to decrease at a low temperature, and deterioration is likely to progress at a high temperature. For this reason, the temperature of the battery 70 needs to be maintained within an appropriate temperature range (in the present embodiment, the temperature is equal to or higher than 15° C. and equal to or lower than 55° C.). Therefore, in the electric vehicle of the present embodiment, the temperature of the battery 70 is adjusted using the vehicle air conditioner 1.

The vehicle air conditioner 1 includes a heat pump cycle 10, a high-temperature side heat medium circuit 30, a low-temperature side heat medium circuit 40, an indoor air conditioning unit 50, a control device 60, and the like.

First, the heat pump cycle 10 will be described with reference to FIG. 1. The heat pump cycle 10 is a vapor compression refrigeration cycle that adjusts the temperatures of ventilation air blown into the vehicle compartment, a high-temperature side heat medium circulating in the high-temperature side heat medium circuit 30, and a low-temperature side heat medium circulating in the low-temperature side heat medium circuit 40. The heat pump cycle 10 is configured to be able to switch a refrigerant circuit depending on various operation modes to be described later in order to perform air conditioning in the vehicle compartment and temperature adjustment of the in-vehicle device.

In the heat pump cycle 10, an HFO refrigerant (specifically, R1234yf) is used as the refrigerant. The heat pump cycle 10 configures a subcritical refrigeration cycle in which the pressure of a high-pressure side refrigerant does not exceed the critical pressure of the refrigerant. Refrigerant oil for lubricating a compressor 11 is mixed in the refrigerant. The refrigerant oil is a PAG oil with compatibility with a liquid-phase refrigerant (that is, polyalkylene glycol oil). A part of the refrigerant oil circulates in the heat pump cycle 10 together with the refrigerant.

The compressor 11 draws, compresses, and discharges the refrigerant in the heat pump cycle 10. The compressor 11 is an electric compressor in which a fixed capacity compression mechanism with a fixed discharge capacity is rotationally driven by an electric motor. The rotation speed (that is, refrigerant discharge capability) of the compressor 11 is controlled by a control signal output from the control device 60 described later.

The compressor 11 is disposed in a drive unit chamber formed on the front side of the vehicle compartment. The drive unit chamber forms a space in which at least a part of a device (for example, a traveling electric motor) or the like used for generating or adjusting drive force for vehicle traveling is disposed.

The inflow port side of a first three-way joint 12a is connected to a discharge port of the compressor 11. The first three-way joint 12a has three inflow and outflow ports communicating with each other. As the first three-way joint 12a, a joint portion formed by joining a plurality of pipes or a joint portion formed by providing a plurality of refrigerant passages in a metal block or a resin block can be used.

As described later, the heat pump cycle 10 further includes second three-way joint 12b to sixth three-way joint 12f. The basic configurations of the second three-way joint 12b to the sixth three-way joint 12f are similar to that of the first three-way joint 12a. The basic configuration of each three-way joint described in embodiments to be described later is also similar to that of the first three-way joint 12a.

When one of the three inflow and outflow ports is used as an inflow port and the remaining two are used as outflow ports in these three-way joints, the flow of the refrigerant is branched. When two of the three inflow and outflow ports are used as inflow ports and the remaining one is used as an outflow port, the flows of the refrigerant are joined. The first three-way joint 12a is a branching portion that branches the flow of the discharge refrigerant discharged from the compressor 11.

The inlet side of a refrigerant passage in a water-refrigerant heat exchanger 13 is connected to one outflow port of the first three-way joint 12a. One inflow port side of the sixth three-way joint 12f is connected to the other outflow port of the first three-way joint 12a.

The refrigerant passage from the other outflow port of the first three-way joint 12a to one inflow port of the sixth three-way joint 12f is a bypass passage 21c. A bypass-side flow rate regulating valve 14d is disposed in the bypass passage 21c.

The bypass-side flow rate regulating valve 14d is a bypass-passage side decompression unit that decompresses a discharge refrigerant (that is, the other discharge refrigerant branched at the first three-way joint 12a) flowing out of the other outflow port of the first three-way joint 12a in a hot gas air-heating mode or the like to be described later. The bypass-side flow rate regulating valve 14d is a bypass-side flow rate regulating unit that regulates the flow rate (in the present embodiment, mass flow rate) of the refrigerant flowing through the bypass passage 21c.

The bypass-side flow rate regulating valve 14d is an electric variable throttle mechanism including a valve body that changes a throttle opening and an electric actuator (specifically, stepping motor) as a drive unit that displaces the valve body. The operation of the bypass-side flow rate regulating valve 14d is controlled by a control pulse output from the control device 60.

The bypass-side flow rate regulating valve 14d has a full open function of functioning as a simple refrigerant passage without exhibiting a refrigerant decompression action and a flow rate regulating action by setting the throttle opening to a fully open state. The bypass-side flow rate regulating valve 14d has a fully closing function of closing the refrigerant passage by setting the throttle opening to a fully closed state.

As described later, the heat pump cycle 10 further includes an air-heating expansion valve 14a, an air-cooling expansion valve 14b, and a cooling expansion valve 14c. The basic configurations of the air-heating expansion valve 14a, the air-cooling expansion valve 14b, and the cooling expansion valve 14c are similar to those of the bypass-side flow rate regulating valve 14d.

The refrigerant circuit can be switched by the air-heating expansion valve 14a, the air-cooling expansion valve 14b, the cooling expansion valve 14c, and the bypass-side flow rate regulating valve 14d exhibiting the fully closing function. Therefore, the air-heating expansion valve 14a, the air-cooling expansion valve 14b, the cooling expansion valve 14c, and the bypass-side flow rate regulating valve 14d function as a refrigerant circuit switching unit.

It is needless to mention that the air-heating expansion valve 14a, the air-cooling expansion valve 14b, the cooling expansion valve 14c, and the bypass-side flow rate regulating valve 14d may be formed by combining a variable throttle mechanism that does not have a fully closing function and an on-off valve that opens and closes a throttle passage. In this case, each on-off valve functions as a refrigerant circuit switching unit.

The water-refrigerant heat exchanger 13 is a radiating heat exchange unit that exchanges heat between the discharge refrigerant (that is, one discharge refrigerant branched at the first three-way joint 12a) flowing out of one outflow port of the first three-way joint 12a and the high-temperature side heat medium circulating in the high-temperature side heat medium circuit 30. In the water-refrigerant heat exchanger 13, the high-temperature side heat medium is heated by radiating heat of the discharge refrigerant to the high-temperature side heat medium.

The inflow port side of the second three-way joint 12b is connected to an outlet port of the refrigerant passage in the water-refrigerant heat exchanger 13. The inlet side of the air-heating expansion valve 14a is connected to one outflow port of the second three-way joint 12b. One inflow port side of a four-way joint 12x is connected to the other outflow port of the second three-way joint 12b.

The refrigerant passage from the other outflow port of the second three-way joint 12b to one inflow port of the four-way joint 12x is a high-pressure side passage 21a. A high-pressure side on-off valve 22a is disposed in the high-pressure side passage 21a.

The high-pressure side on-off valve 22a is an on-off valve that opens and closes the high-pressure side passage 21a. The high-pressure side on-off valve 22a is an electromagnetic valve whose opening and closing operation is controlled by a control voltage output from the control device 60. The high-pressure side on-off valve 22a can switch the refrigerant circuit by opening and closing the high-pressure side passage 21a. Therefore, the high-pressure side on-off valve 22a is a refrigerant circuit switching unit.

The four-way joint 12x is a joint portion having four inflow and outflow ports communicating with each other. As the four-way joint 12x, a joint portion formed in a manner similar to that of the three-way joint described above can be used. The four-way joint 12x may be formed by combining two three-way joints.

The air-heating expansion valve 14a is an outdoor heat-exchanger side decompression unit that decompresses the refrigerant flowing into an outdoor heat exchanger 15 in an outside air endothermic and air-heating mode or the like to be described later. The air-heating expansion valve 14a is an outdoor heat-exchanger side flow rate regulating unit that regulates the flow rate of the refrigerant flowing into the outdoor heat exchanger 15.

The refrigerant inlet side of the outdoor heat exchanger 15 is connected to an outlet port of the air-heating expansion valve 14a. The outdoor heat exchanger 15 is an outside air heat exchange unit that exchanges heat between the refrigerant flowing out of the air-heating expansion valve 14a and outside air blown by an outside air fan (not illustrated). The outdoor heat exchanger 15 is disposed on the front side of the drive unit chamber. For this reason, during traveling of the vehicle, the traveling air flowing into the drive unit chamber through a grill can be blown against the outdoor heat exchanger 15.

The inlet side of the third three-way joint 12c is connected to a refrigerant outlet port of the outdoor heat exchanger 15. Another inflow port side of the four-way joint 12x is connected to one outflow port of the third three-way joint 12c via a first check valve 16a. One inflow port side of the fourth three-way joint 12d is connected to the other outflow port of the third three-way joint 12c.

The refrigerant passage from the other outflow port of the third three-way joint 12c to one inflow port of the fourth three-way joint 12d is a low-pressure side passage 21b. A low-pressure side on-off valve 22b is disposed in the low-pressure side passage 21b.

The low-pressure side on-off valve 22b is an on-off valve that opens and closes the low-pressure side passage 21b. The basic configuration of the low-pressure side on-off valve 22b is similar to that of the high-pressure side on-off valve 22a. Therefore, the low-pressure side on-off valve 22b is a refrigerant circuit switching unit. The basic configuration of each on-off valve described in embodiments to be described later is also similar to that of the high-pressure side on-off valve 22a.

The first check valve 16a allows the refrigerant to flow from the third three-way joint 12c side to the four-way joint 12x side, and prohibits the refrigerant from flowing from the four-way joint 12x side to the third three-way joint 12c side.

The refrigerant inlet side of an indoor evaporator 18 is connected to one outflow port of the four-way joint 12x via the air-cooling expansion valve 14b.

The air-cooling expansion valve 14b is an indoor-evaporator side decompression unit that decompresses the refrigerant flowing into the indoor evaporator 18 in an air-cooling mode or the like to be described later. The air-cooling expansion valve 14b is also an indoor-evaporator side flow rate regulating unit that regulates the flow rate of the refrigerant flowing into the indoor evaporator 18.

The indoor evaporator 18 is disposed in an air conditioning case 51 of the indoor air conditioning unit 50 described later. The indoor evaporator 18 is an air-cooling heat exchange unit that exchanges heat between the low-pressure refrigerant decompressed by the air-cooling expansion valve 14b and ventilation air blown from an indoor blower 52 toward the vehicle compartment. In the indoor evaporator 18, the ventilation air is cooled by evaporating the low-pressure refrigerant to exhibit the endothermic action.

One inflow port side of the fifth three-way joint 12e is connected to a refrigerant outlet port of the indoor evaporator 18 via a second check valve 16b. The second check valve 16b allows the refrigerant to flow from the refrigerant outlet side of the indoor evaporator 18 to the fifth three-way joint 12e side, and prohibits the refrigerant from flowing from the fifth three-way joint 12e side to the refrigerant outlet side of the indoor evaporator 18.

The other inflow port side of the sixth three-way joint 12f is connected to another outflow port of the four-way joint 12x via the cooling expansion valve 14c. The inlet side of a refrigerant passage in a chiller 20 is connected to an outflow port of the sixth three-way joint 12f.

The cooling expansion valve 14c is a chiller-side decompression unit that decompresses the refrigerant flowing into the chiller 20 in a hot gas air-heating mode described later, an operation mode for cooling the battery 70, or the like. The cooling expansion valve 14c is a chiller-side flow rate regulating unit that regulates the flow rate of the refrigerant flowing into the chiller 20.

The chiller 20 is a endothermic heat exchange unit that exchanges heat between the low-pressure refrigerant decompressed by the cooling expansion valve 14c and the low-temperature side heat medium circulating in the low-temperature side heat medium circuit 40. In the chiller 20, the low-temperature side heat medium is cooled by evaporating the low-pressure refrigerant to exhibit the endothermic action.

The other inflow port side of the fourth three-way joint 12d is connected to an outlet port of the refrigerant passage in the chiller 20. The other inflow port side of the fifth three-way joint 12e is connected to an outflow port of the fourth three-way joint 12d.

The inlet side of an accumulator 23 is connected to an outflow port of the fifth three-way joint 12e. The accumulator 23 is a low-pressure side gas-liquid separator that separates the refrigerant flowing into the accumulator into gas and liquid, and stores the separated liquid-phase refrigerant as a surplus refrigerant in the cycle. A gas-phase refrigerant outlet port of the accumulator 23 is connected to the suction port side of the compressor 11.

Next, the high-temperature side heat medium circuit 30 will be described. The high-temperature side heat medium circuit 30 is a circuit for circulating the high-temperature side heat medium. In the present embodiment, an ethylene glycol aqueous solution is used as the high-temperature side heat medium. In the high-temperature side heat medium circuit 30, a high-temperature side pump 31, a heater core 32, a heat medium passage of the water-refrigerant heat exchanger 13, and the like are arranged.

The high-temperature side pump 31 is a high-temperature side heat medium pumping unit that sucks the high-temperature side heat medium flowing out of the heater core 32 and pumps the high-temperature side heat medium to the inlet side of the heat medium passage in the water-refrigerant heat exchanger 13. The high-temperature side pump 31 is an electric pump whose rotation speed (that is, pumping capability) is controlled by a control voltage output from the control device 60.

The heater core 32 is an air heating heat exchanger that exchanges heat between the high-temperature side heat medium heated by the water-refrigerant heat exchanger 13 and ventilation air having passed through the indoor evaporator 18 to heat the ventilation air. The heater core 32 is disposed in the air conditioning case 51 of the indoor air conditioning unit 50. The suction port side of the high-temperature side pump 31 is connected to a heat medium outlet port of the heater core 32.

Therefore, in the high-temperature side heat medium circuit 30, by operating the high-temperature side pump 31, the high-temperature side heat medium heated by the water-refrigerant heat exchanger 13 can flow into the heater core 32. In the heater core 32, heat can be exchanged between the high-temperature side heat medium and the ventilation air to heat the ventilation air.

Therefore, the water-refrigerant heat exchanger 13 and each component of the high-temperature side heat medium circuit 30 in the present embodiment are heating units that heat ventilation air as an object to be heated using the refrigerant flowing out of one outflow port of the first three-way joint 12a as a heat source.

The cooling expansion valve 14c is a heating-unit side decompression unit that decompresses the refrigerant flowing out of the water-refrigerant heat exchanger 13 forming the heating unit in the hot gas air-heating mode or the like. The sixth three-way joint 12f is a joining portion that joins the flow of the refrigerant flowing out of the cooling expansion valve 14c and the flow of the bypass-side refrigerant flowing out of the bypass-side flow rate regulating valve 14d to cause the joined flow of the refrigerant to flow to the suction port side of the compressor 11 in the hot gas air-heating mode or the like.

Next, the low-temperature side heat medium circuit 40 will be described. The low-temperature side heat medium circuit 40 is a circuit for circulating the low-temperature side heat medium. In the present embodiment, the same type of fluid as the high-temperature side heat medium is used as the low-temperature side heat medium. In the low-temperature side heat medium circuit 40, a first low-temperature side pump 41a, a second low-temperature side pump 41b, a heat medium three-way valve 42, a heat medium four-way valve 43, a heating passage 44a of a heat medium electric heater 44, a cooling water passage 70a of the battery 70, the heat medium passage of the chiller 20, and the like are arranged.

The first low-temperature side pump 41a is a low-temperature side heat medium pumping unit that sucks the low-temperature side heat medium flowing out of one outflow port of the heat medium four-way valve 43 and pumps the low-temperature side heat medium to the heating passage 44a of the heat medium electric heater 44. The second low-temperature side pump 41b is a low-temperature side heat medium pumping unit that sucks the low-temperature side heat medium flowing out of another outflow port of the heat medium four-way valve 43 and pumps the low-temperature side heat medium to the cooling water passage 70a of the battery 70.

The basic configurations of the first low-temperature side pump 41a and the second low-temperature side pump 41b are similar to that of the high-temperature side pump 31. The first low-temperature side pump 41a and the second low-temperature side pump 41b can regulate the flow rate of the heat medium circulating in the heat medium circuit. Therefore, the first low-temperature side pump 41a and the second low-temperature side pump 41b of the present embodiment are heat medium flow rate regulating units that regulate the inflow rate of the heat medium flowing into the heat medium passage of the chiller 20.

The heat medium electric heater 44 is a heat generating unit that generates heat by receiving supply of electric power. In the present embodiment, a PTC heater having a PTC element (that is, positive characteristic thermistor) is used as the heat medium electric heater 44. The amount of heat generated by the heat medium electric heater 44 is controlled by the electric power supplied from the control device 60.

The heating passage 44a is a heat medium passage through which the low-temperature side heat medium pumped from the first low-temperature side pump 41a flows. The heating passage 44a is formed integrally with a case in which the heat medium electric heater 44 is housed. Therefore, when the low-temperature side heat medium is caused to flow through the heating passage 44a while the heat medium electric heater 44 generates heat, the low-temperature side heat medium can be heated by the heat generated by the heat medium electric heater 44.

The inflow port side of the heat medium three-way valve 42 is connected to a heat medium outlet port of the heating passage 44a. The inlet side of the heat medium passage in the chiller 20 is connected to one outflow port of the heat medium three-way valve 42. The inlet side of a heat medium bypass passage 45 is connected to the other outflow port of the heat medium three-way valve 42. The heat medium bypass passage 45 is a heat medium passage through which the low-temperature side heat medium flowing out of the heating passage 44a flows while bypassing the heat medium passage of the chiller 20.

The heat medium three-way valve 42 is a heat medium circuit switching unit that switches the circuit configuration of the low-temperature side heat medium circuit 40. The operation of the heat medium three-way valve 42 is controlled by a control voltage output from the control device 60.

Specifically, the heat medium three-way valve 42 can switch to a circuit that connects the outlet side of the heating passage 44a and the inlet side of the heat medium passage in the chiller 20. The heat medium three-way valve 42 can also switch to a circuit that connects the outlet side of the heating passage 44a and the inlet side of the heat medium bypass passage 45.

One inflow port side of a heat medium three-way joint 46 is connected to an outlet port of the heat medium passage in the chiller 20. The other inflow port side of the heat medium three-way joint 46 is connected to an outlet port of the heat medium bypass passage 45. One inflow port side of the heat medium four-way valve 43 is connected to an outflow port of the heat medium three-way joint 46. The basic configuration of the heat medium three-way joint 46 is similar to that of the first three-way joint 12a of the heat pump cycle 10 and the like.

The heat medium four-way valve 43 is a heat medium circuit switching unit that switches the circuit configuration of the low-temperature side heat medium circuit 40. The operation of the heat medium four-way valve 43 is controlled by a control voltage output from the control device 60.

Specifically, the heat medium four-way valve 43 can switch to a circuit that connects the outflow port side of the heat medium three-way joint 46 and the suction port side of the second low-temperature side pump 41b, and at the same time, connects the outlet side of the cooling water passage 70a in the battery 70 and the suction port side of the first low-temperature side pump 41a. The heat medium four-way valve 43 can also switch to a circuit that connects the outflow port side of the heat medium three-way joint 46 and the suction port side of the first low-temperature side pump 41a, and at the same time, connects the outlet side of the cooling water passage 70a in the battery 70 and the suction port side of the second low-temperature side pump 41b.

The cooling water passage 70a of the battery 70 is a heat medium passage through which the low-temperature side heat medium pumped from the second low-temperature side pump 41b flows. The cooling water passage 70a is formed inside a battery dedicated case that houses a plurality of stacked battery cells.

Therefore, the battery 70 can be cooled by the low-temperature side heat medium with low temperature flowing through the cooling water passage 70a when the battery 70 generates heat. In other words, by the low-temperature side heat medium with low temperature flowing through the cooling water passage 70a when the battery 70 generates heat, the low-temperature side heat medium can be heated by the heat generated by the battery 70.

The passage configuration of the cooling water passage 70a is a passage configuration in which a plurality of passages are connected in parallel inside the battery dedicated case. As a result, all the battery cells can be uniformly cooled in the cooling water passage 70a. Another inflow port side of the heat medium four-way valve 43 is connected to an outlet port of the cooling water passage 70a.

Therefore, the heat medium electric heater 44 and the battery 70 of the present embodiment are heat generating units that generate heat for heating the low-temperature side heat medium.

The amount of heat generated by the heat medium electric heater 44 can be controlled by the electric power supplied from the control device 60. Therefore, the heat medium electric heater 44 of the present embodiment is a high controllable heat generating unit capable of easily controlling the amount of heat generated to an amount desired by the user. The heat medium electric heater 44 is also a preferential heat generating unit whose amount of heat generated is preferentially controlled in order to adjust the temperature of the low-temperature side heat medium.

On the other hand, the battery 70 is discharged depending on the needs of various in-vehicle devices during traveling and stoppage of the vehicle, and is charged in accordance with specifications of a charger or the like during charging. For this reason, the amount of heat generated by the battery 70 is less easily controlled than the high controllable heat generating unit. Therefore, the battery 70 of the present embodiment is a low controllable heat generating unit with lower controllability than the high controllable heat generating unit. The low controllable heat generating unit also includes a heat generating unit whose amount of heat generated cannot be controlled by the control device 60. The battery 70 is also a low priority heat generating unit whose amount of heat generated is controlled with a lower priority than the preferential heat generating unit.

The low-temperature side heat medium circuit 40 is a heat medium circuit that circulates the low-temperature side heat medium heated by the heat medium electric heater 44 or the battery 70. The chiller 20 is a endothermic unit that causes the refrigerant flowing out of the sixth three-way joint 12f to absorb heat generated by the heat medium electric heater 44 and the battery 70 via the low-temperature side heat medium.

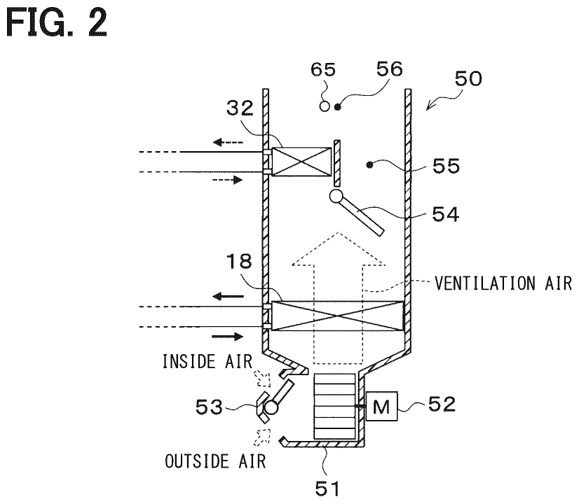

Next, the indoor air conditioning unit 50 will be described with reference to FIG. 2. The indoor air conditioning unit 50 is a unit in which a plurality of components are integrated in order to blow ventilation air whose temperature has been adjusted to an appropriate temperature for air conditioning in the vehicle compartment to an appropriate location in the vehicle compartment. The indoor air conditioning unit 50 is disposed inside an instrument panel (instrument panel) at the foremost part of the vehicle compartment.

The indoor air conditioning unit 50 is formed by housing the indoor blower 52, the indoor evaporator 18, the heater core 32, and the like in the air conditioning case 51 forming an air passage for ventilation air. The air conditioning case 51 is made of resin (for example, polypropylene) with a certain degree of elasticity and excellent strength.

An inside air and outside air switching device 53 is disposed on the most upstream side of ventilation air flow in the air conditioning case 51. The inside air and outside air switching device 53 selectively introduces inside air (that is, air inside vehicle compartment) or/and outside air (that is, air outside vehicle compartment) into the air conditioning case 51. The operation of the inside air and outside air switching device 53 is controlled by a control signal output from the control device 60.

The indoor blower 52 is disposed on the ventilation air flow downstream side of the inside air and outside air switching device 53. The indoor blower 52 is a blower unit that blows air introduced through the inside air and outside air switching device 53 toward the vehicle compartment. The rotation speed (that is blowing capability) of the indoor blower 52 is controlled by a control voltage output from the control device 60.

The indoor evaporator 18 and the heater core 32 are arranged on the ventilation air flow downstream side of the indoor blower 52. The indoor evaporator 18 is disposed on the ventilation air flow upstream side of the heater core 32. A cold air bypass passage 55 through which the ventilation air having passed through the indoor evaporator 18 flows while bypassing the heater core 32 is formed in the air conditioning case 51.

An air mix door 54 is disposed on the ventilation air flow downstream side of the indoor evaporator 18 in the air conditioning case 51 and on the ventilation air flow upstream side of the heater core 32 and the cold air bypass passage 55 in the air conditioning case 51.

The air mix door 54 adjusts the air volume ratio between the air volume of the ventilation air passing through the heater core 32 and the air volume of the ventilation air passing through the cold air bypass passage 55 in the ventilation air having passed through the indoor evaporator 18. The operation of an actuator for driving the air mix door 54 is controlled by a control signal output from the control device 60.

A mixing space 56 is formed on the ventilation air flow downstream side of the heater core 32 and the cold air bypass passage 55. The mixing space 56 is a space where the ventilation air heated by the heater core 32 and the ventilation air that has passed through the cold air bypass passage 55 and has not been heated are mixed.

Therefore, in the indoor air conditioning unit 50, by adjusting the opening of the air mix door 54, the temperature of the ventilation air (that is, conditioned air) mixed in the mixing space 56 and blown into the vehicle compartment can be adjusted. The air mix door 54 of the present embodiment is an air flow rate regulating unit that regulates the flow rate of the ventilation air subjected to heat exchange at the heater core 32.

A plurality of opening holes (not illustrated) for blowing conditioned air to various locations in the vehicle compartment are formed at the most downstream portion of the ventilation air flow in the air conditioning case 51. A blowing mode door (not illustrated) that opens and closes each opening hole is disposed in each of the plurality of opening holes. The operation of an actuator for driving the blowing mode door is controlled by a control signal output from the control device 60.

Therefore, in the indoor air conditioning unit 50, by switching the opening holes opened and closed by the blowing mode doors, the conditioned air whose temperature has been adjusted to an appropriate temperature can be blown to an appropriate location in the vehicle compartment.

Next, an electric control unit of the present embodiment will be described. The control device 60 includes a known microcomputer including a CPU, a ROM, a RAM, and the like, and peripheral circuits thereof. The control device 60 performs various calculations and processing on the basis of a control program stored in the ROM. The control device 60 then controls operations of various control target devices connected to the output side on the basis of the calculation and processing results.

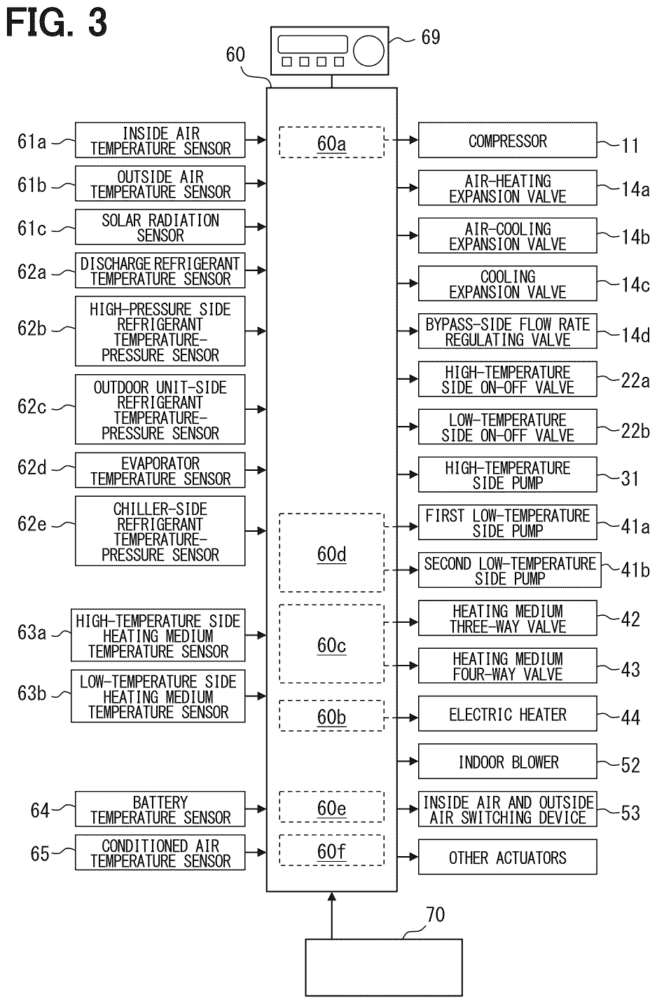

As illustrated in the block diagram of FIG. 3, a control sensor group is connected to the input side of the control device 60, and the control sensor group includes an inside air temperature sensor 61a, an outside air temperature sensor 61b, a solar radiation amount sensor 61c, a discharge refrigerant temperature sensor 62a, a high-pressure side refrigerant temperature-pressure sensor 62b, an outdoor unit-side refrigerant temperature-pressure sensor 62c, an evaporator temperature sensor 62d, a chiller-side refrigerant temperature-pressure sensor 62e, a high-temperature side heat medium temperature sensor 63a, a low-temperature side heat medium temperature sensor 63b, a battery temperature sensor 64, a conditioned air temperature sensor 65 and the like.

The inside air temperature sensor 61a is an inside air temperature detecting unit that detects a vehicle compartment temperature (inside air temperature) Tr. The outside air temperature sensor 61b is an outside air temperature detecting unit that detects a vehicle-outside temperature (outside air temperature) Tam. The solar radiation amount sensor 61c is a solar radiation amount detecting unit that detects a solar radiation amount As with which the vehicle compartment is irradiated.

The discharge refrigerant temperature sensor 62a is a discharge refrigerant temperature detecting unit that detects a discharge refrigerant temperature Td of the discharge refrigerant discharged from the compressor 11.

The high-pressure side refrigerant temperature-pressure sensor 62b is a high-pressure side refrigerant temperature-pressure detecting unit that detects a high-pressure side refrigerant temperature T1, which is the temperature of the refrigerant flowing out of the water-refrigerant heat exchanger 13, and a discharge refrigerant pressure Pd, which is the pressure of the refrigerant flowing out of the water-refrigerant heat exchanger 13. The discharge refrigerant pressure Pd can be used as the pressure of the discharge refrigerant discharged from the compressor 11.

The outdoor unit-side refrigerant temperature-pressure sensor 62c is an outdoor unit-side refrigerant temperature-pressure detecting unit that detects an outdoor unit-side refrigerant temperature T2, which is the temperature of the refrigerant flowing out of the outdoor heat exchanger 15, and an outdoor unit-side refrigerant pressure P2, which is the pressure of the refrigerant flowing out of the outdoor heat exchanger 15. Specifically, the temperature and the pressure of the refrigerant flowing through the refrigerant passage from the refrigerant outlet port of the outdoor heat exchanger 15 to the inflow port of the third three-way joint 12c.

The evaporator temperature sensor 62d is an evaporator temperature detecting unit that detects a refrigerant evaporating temperature (evaporator temperature) Tefin in the indoor evaporator 18. Specifically, the evaporator temperature sensor 62d detects a heat exchange fin temperature of the indoor evaporator 18.

The chiller-side refrigerant temperature-pressure sensor 62e is a chiller-side refrigerant temperature-pressure detecting unit that detects a chiller-side refrigerant temperature Tc, which is the temperature of the refrigerant flowing out of the refrigerant passage in the chiller 20, and a chiller-side refrigerant pressure Pc, which is the pressure of the refrigerant flowing out of the refrigerant passage in the chiller 20. The chiller-side refrigerant pressure Pc of the present embodiment can be used as the suction refrigerant pressure Ps, which is the pressure of the suction refrigerant drawn into the compressor 11.

In the present embodiment, as the refrigerant temperature-pressure sensor, a detection unit in which the pressure detecting unit and the temperature detecting unit are integrated is used, but it is needless to mention that the pressure detecting unit and the temperature detecting unit configured separately may be used.

The high-temperature side heat medium temperature sensor 63a is a high-temperature side heat medium temperature detecting unit that detects a high-temperature side heat medium temperature TWH, which is the temperature of the high-temperature side heat medium flowing into the heater core 32.

The low-temperature side heat medium temperature sensor 63b is a low-temperature side heat medium temperature detecting unit that detects a low-temperature side heat medium temperature TWL, which is the temperature of the low-temperature side heat medium flowing into the heat medium three-way valve 42 from the heating passage 44a of the heat medium electric heater 44. The low-temperature side heat medium temperature TWL of the present embodiment can be used as an inflow temperature TWLC, which is the temperature of the heat medium flowing into the heat medium passage of the chiller 20 from the heat medium three-way valve 42.

The battery temperature sensor 64 is a battery temperature detecting unit that detects a battery temperature TB, which is the temperature of the battery 70. The battery temperature sensor 64 includes a plurality of temperature sensors, and detects temperatures at a plurality of locations of the battery 70. Therefore, the control device 60 can detect a temperature difference between and a temperature distribution of the individual battery cells forming the battery 70. An average value of detected values of the plurality of temperature sensors is used as the battery temperature TB.

The conditioned air temperature sensor 65 is a conditioned air temperature detecting unit that detects a temperature TAV of ventilation air blown into the vehicle compartment from the mixing space 56. The ventilation air temperature TAV is an object temperature of the ventilation air as an object to be heated.

As illustrated in FIG. 3, an operation panel 69 disposed near the instrument panel at the front part of the vehicle compartment is connected to the input side of the control device 60 in a wired or wireless manner. Operation signals from various operation switches provided on the operation panel 69 are input to the control device 60.

Specific examples of the various operation switches provided on the operation panel 69 include an auto-switch, an air conditioner switch, an air volume setting switch, and a temperature setting switch.

The auto-switch is an automatic control setting unit that sets or cancels the automatic control operation of the vehicle air conditioner 1. The air conditioner switch is a cooling request unit that requests the indoor evaporator 18 to cool ventilation air. The air volume setting switch is an air volume setting unit that manually sets the air volume of the indoor blower 52. The temperature setting switch is a temperature setting unit that sets a set temperature Tset in the vehicle compartment.

The control device 60 of the present embodiment is integrally configured with control units that control various control target devices connected to the output side thereof. Therefore, the configuration (hardware and software) that controls the operation of each control target device configures the control unit that controls the operation of each control target device.

For example, in the control device 60, the configuration that controls the refrigerant discharge capability of the compressor 11 configures a discharge capability control unit 60a. The configuration that controls the amount of heat generated by the heat medium electric heater 44 as the high controllable heat generating unit configures a heat generation amount control unit 60b. The configuration that controls the operations of the heat medium three-way valve 42 and the heat medium four-way valve 43 as heat medium circuit switching units configures a heat medium circuit control unit 60c. The configuration that controls the operations of the first low-temperature side pump 41a and the second low-temperature side pump 41b as heat medium flow rate regulating units configures an inflow rate regulating unit 60d.

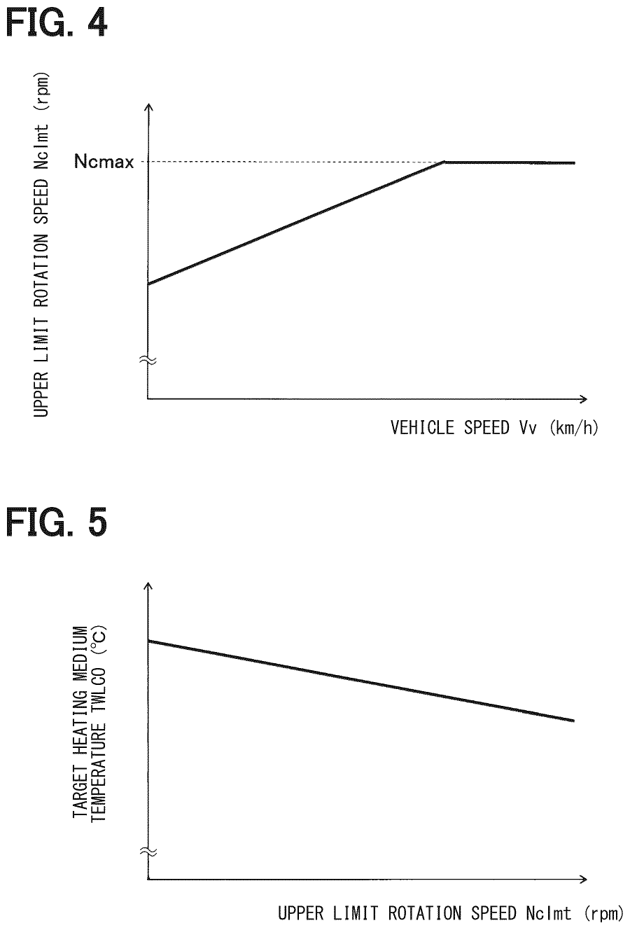

The configuration that determines an upper limit rotation speed Nclmt of the compressor 11 configures an upper limit rotation speed determining unit 60e. As illustrated in the control characteristic diagram of FIG. 4, in the upper limit rotation speed determining unit 60e of the present embodiment, the upper limit rotation speed Nclmt is reduced along with a decrease in vehicle speed Vv within the range of a maximum rotation speed Ncmax or less determined from the durability of the compressor 11. This is because the noise level allowed for the compressor 11 decreases as the vehicle speed Vv decreases.

The configuration that determines a target heat medium temperature TWLCO of the inflow temperature TWLC configures a target heat medium temperature determining unit 60f. The target heat medium temperature TWLCO is determined to be higher than the chiller-side refrigerant temperature Tc detected by the chiller-side refrigerant temperature-pressure sensor 62e. In other words, it is determined that the low-pressure refrigerant can absorb heat from the low-temperature side heat medium in the chiller 20.

In the target heat medium temperature determining unit 60f of the present embodiment, as illustrated in the control characteristic diagram of FIG. 5, the target heat medium temperature TWLCO is increased as the upper limit rotation speed Nclmt decreases. That is, the total amount of heat generated by the battery 70 and the heat medium electric heater 44 is increased as the upper limit rotation speed Nclmt increases. This is because the compression workload of the compressor 11 tends to decrease as the upper limit rotation speed Nclmt decreases.

Next, the operation of the vehicle air conditioner 1 of the present embodiment with the above configuration will be described. In the vehicle air conditioner 1 of the present embodiment, various operation modes are switched in order to perform air conditioning in the vehicle compartment and temperature adjustment of the battery 70. Switching of the operation mode is performed by executing a control program stored in advance in the control device 60.

In the control program, detection signals of the control sensor group and operation signals of the operation panel 69 described above are read. A target blowing temperature TAO, which is a target temperature of ventilation air blown into the vehicle compartment, is calculated on the basis of the read detection signal and operation signal. In addition, the operation mode is selected on the basis of the detection signal, the operation signal, the target blowing temperature TAO, and the like, and the operations of various control target devices are controlled based on the selected operation mode.

Thereafter, until the termination condition of the control program is satisfied, the control routine of reading the detection signal and the operation signal, calculating the target blowing temperature TAO, selecting the operation mode, and controlling various control target devices is repeated every predetermined control cycle.

The target blowing temperature TAO is calculated using the following Formula F1.

TAO=Kset×Tset−Kr×Tr−Kam×Tam−Ks×As+C (F1)

Tset is a set temperature in the vehicle compartment set by the temperature setting switch. Tr is an inside air temperature detected by the inside air temperature sensor 61a. Tam is an outside air temperature detected by the outside air temperature sensor 61b. As is a solar radiation amount detected by the solar radiation amount sensor 61c. Kset, Kr, Kam, and Ks are control gains, and C is a correction constant. Each operation mode will be described below.

### (a) Air-Cooling Mode

The air-cooling mode is an operation mode in which the vehicle compartment is cooled by blowing cooled ventilation air into the vehicle compartment. The air-cooling mode tends to be selected when the outside air temperature Tam is relatively high (equal to or higher than 25° C. in the present embodiment) or when the target blowing temperature TAO is a relatively low value in a state where the auto-switch and the air conditioner switch are turned on.

The air-cooling mode includes a single air-cooling mode and a cooling and air-cooling mode. The single air-cooling mode is an operation mode in which the vehicle compartment is cooled without cooling the battery 70. The cooling and air-cooling mode is an operation mode in which the battery 70 is cooled and at the same time, the vehicle compartment is cooled.

In the control program of the present embodiment, an operation mode of cooling the battery 70 is performed when the battery temperature TB detected by the battery temperature sensor 64 is equal to or higher than a predetermined reference cooling temperature KTB1. The same applies to other operation modes described below.

(a-1) Single Air-Cooling Mode

In the heat pump cycle 10 in the single air-cooling mode, the control device 60 brings the air-heating expansion valve 14a into a fully open state, brings the air-cooling expansion valve 14b into a throttled state that exhibits the refrigerant decompression action, brings the cooling expansion valve 14c into a fully closed state, and brings the bypass-side flow rate regulating valve 14d into the fully closed state. The control device 60 closes the high-pressure side on-off valve 22a and closes the low-pressure side on-off valve 22b.

In the heat pump cycle 10, the control device 60 controls the operation of the expansion valve in the throttled state such that the suction refrigerant introduced into the accumulator 23 is close to a saturated gas-phase refrigerant.

Therefore, in the heat pump cycle 10 in the single air-cooling mode, the refrigerant circuit is switched to a refrigerant circuit in which the refrigerant discharged from the compressor 11 circulates through the water-refrigerant heat exchanger 13, the air-heating expansion valve 14a in the fully open state, the outdoor heat exchanger 15, the air-cooling expansion valve 14b in the throttled state, the indoor evaporator 18, the accumulator 23, and the suction port of the compressor 11 in this order.

In the high-temperature side heat medium circuit 30 in the single air-cooling mode, the control device 60 operates the high-temperature side pump 31 so as to exhibit a predetermined reference pumping capability. Therefore, in the high-temperature side heat medium circuit 30 in the single air-cooling mode, the high-temperature side heat medium pumped from the high-temperature side pump 31 circulates through the heat medium passage of the water-refrigerant heat exchanger 13, the heater core 32, and the suction port of the high-temperature side pump 31 in this order.

In the low-temperature side heat medium circuit 40 in the single air-cooling mode, the control device 60 stops the first low-temperature side pump 41a and the second low-temperature side pump 41b.

In the indoor air conditioning unit 50 in the single air-cooling mode, the control device 60 controls the rotation speed of the indoor blower 52 with reference to a control map stored in advance in the control device 60 on the basis of the target blowing temperature TAO.

The control device 60 adjusts the opening of the air mix door 54 such that the ventilation air temperature TAV detected by the conditioned air temperature sensor 65 approaches the target blowing temperature TAO. In addition, the control device 60 appropriately controls the operations of other control target devices.

Therefore, in the heat pump cycle 10 in the single air-cooling mode, a vapor compression refrigeration cycle is configured in which the water-refrigerant heat exchanger 13 and the outdoor heat exchanger 15 function as condensers that radiate heat of the refrigerant and condense the refrigerant, and the indoor evaporator 18 functions as an evaporator that evaporates the refrigerant. In the operation mode in which the indoor evaporator 18 evaporates the refrigerant, the refrigerant evaporating temperature at the indoor evaporator 18 is adjusted within a range in which frost formation in the indoor evaporator 18 can be reduced or prevented.

In the high-temperature side heat medium circuit 30 in the single air-cooling mode, the high-temperature side heat medium flowing into the heat medium passage of the water-refrigerant heat exchanger 13 exchanges heat with the refrigerant discharged from the compressor 11 to be heated. The high-temperature side heat medium heated by the water-refrigerant heat exchanger 13 flows into the heater core 32 and exchanges heat with ventilation air. As a result, the ventilation air is heated.

In the indoor air conditioning unit 50 in the single air-cooling mode, the ventilation air blown from the indoor blower 52 is cooled by heat being absorbed by the refrigerant when passing through the indoor evaporator 18. The ventilation air cooled by the indoor evaporator 18 exchanges heat with the high-temperature side heat medium in the heater core 32 and is reheated depending on the opening of the air mix door 54. The ventilation air whose temperature has been adjusted so as to approach the target blowing temperature TAO is blown into the vehicle compartment, so that the vehicle compartment is cooled.

### (a-2 Cooling and Air-Cooling Mode)

In the heat pump cycle 10 in the cooling and air-cooling mode, the control device 60 brings the cooling expansion valve 14c into the throttled state as compared with the single air-cooling mode.

For this reason, in the heat pump cycle 10 in the cooling and air-cooling mode, the refrigerant discharged from the compressor 11 circulates as in the single air-cooling mode. At the same time, the refrigerant circuit is switched to a refrigerant circuit in which the refrigerant discharged from the compressor 11 circulates through the water-refrigerant heat exchanger 13, the air-heating expansion valve 14a in the fully open state, the outdoor heat exchanger 15, the cooling expansion valve 14c in the throttled state, the chiller 20, the accumulator 23, and the suction port of the compressor 11 in this order. That is, the refrigerant circuit is switched to a refrigerant circuit in which the indoor evaporator 18 and the chiller 20 are connected in parallel to the refrigerant flow.

In the high-temperature side heat medium circuit 30 in the cooling and air-cooling mode, the control device 60 operates the high-temperature side pump 31 as in the single air-cooling mode.

In the low-temperature side heat medium circuit 40 in the cooling and air-cooling mode, the control device 60 controls the operation of the heat medium three-way valve 42 so as to connect the outlet side of the heating passage 44a in the heat medium electric heater 44 and the inlet side of the heat medium passage in the chiller 20.

The control device 60 controls the operation of the heat medium four-way valve 43 so as to connect the outflow port side of the heat medium three-way joint 46 and the suction port side of the second low-temperature side pump 41b, and at the same time, connect the outlet side of the cooling water passage 70a in the battery 70 and the suction port side of the first low-temperature side pump 41a.

In addition, the control device 60 operates the first low-temperature side pump 41a and the second low-temperature side pump 41b so as to exhibit a predetermined reference pumping capability in the cooling and air-cooling mode. The control device 60 stops supply of electric power to the heat medium electric heater 44.

Therefore, in the low-temperature side heat medium circuit 40 in the cooling and air-cooling mode, the low-temperature side heat medium pumped from the first low-temperature side pump 41a flows through the heating passage 44a of the heat medium electric heater 44, the heat medium three-way valve 42, the heat medium passage of the chiller 20, the heat medium four-way valve 43, and the suction port of the second low-temperature side pump 41b in this order. In addition, the low-temperature side heat medium pumped from the second low-temperature side pump 41b flows through the cooling water passage 70a of the battery 70, the heat medium four-way valve 43, and the suction port of the first low-temperature side pump 41a in this order.

In the indoor air conditioning unit 50 in the cooling and air-cooling mode, the control device 60 controls the rotation speed of the indoor blower 52, the opening of the air mix door 54, and the like as in the single air-cooling mode. In addition, the control device 60 appropriately controls the operations of other control target devices. Therefore, in the heat pump cycle 10 in the cooling and air-cooling mode, a vapor compression refrigeration cycle is configured in which the water-refrigerant heat exchanger 13 and the outdoor heat exchanger 15 function as condensers, and the indoor evaporator 18 and the chiller 20 function as evaporators.

In the high-temperature side heat medium circuit 30 in the cooling and air-cooling mode, the high-temperature side heat medium heated by the water-refrigerant heat exchanger 13 flows into the heater core 32 as in the single air-cooling mode.

In the low-temperature side heat medium circuit 40 in the cooling and air-cooling mode, the low-temperature side heat medium flowing into the heat medium passage of the chiller 20 exchanges heat with the low-pressure refrigerant decompressed by the cooling expansion valve 14c to be cooled. The low-temperature side heat medium cooled by the chiller 20 flows into the cooling water passage 70a of the battery 70 and absorbs heat generated by the battery 70. As a result, the battery 70 is cooled.

In the indoor air conditioning unit 50 in the cooling and air-cooling mode, as in the single air-cooling mode, the ventilation air whose temperature has been adjusted is blown into the vehicle compartment, so that the vehicle compartment is cooled.

### (b) Dehumidifying and Air-Heating Mode

The dehumidifying and air-heating mode is an operation mode in which the vehicle compartment is dehumidified and heated by reheating cooled and dehumidified ventilation air and blowing the heated ventilation air into the vehicle compartment. The dehumidifying and air-heating mode tends to be selected when the outside air temperature Tam is in an intermediate temperature range (equal to or higher than 0° C. and lower than 25° C. in the present embodiment) or when the target blowing temperature TAO is in the intermediate temperature range in a state where the auto-switch and the air conditioner switch are turned on.

The dehumidifying and air-heating mode includes a single dehumidifying and air-heating mode, and a cooling and dehumidifying and air-heating mode. The single dehumidifying and air-heating mode is an operation mode in which the vehicle compartment is dehumidified and heated without cooling the battery 70. The cooling and dehumidifying and air-heating mode is an operation mode in which the battery 70 is cooled and at the same time, the vehicle compartment is dehumidified and heated.

(b-1) Single Dehumidifying and Air-Heating Mode

In the heat pump cycle 10 in the single dehumidifying and air-heating mode, the control device 60 brings the air-heating expansion valve 14a into the throttled state, brings the air-cooling expansion valve 14b into the throttled state, brings the cooling expansion valve 14c into the fully closed state, and brings the bypass-side flow rate regulating valve 14d into the fully closed state. The control device 60 closes the high-pressure side on-off valve 22a and closes the low-pressure side on-off valve 22b.

Therefore, in the heat pump cycle 10 in the single dehumidifying and air-heating mode, the refrigerant circuit is switched to a refrigerant circuit in which the refrigerant discharged from the compressor 11 circulates through the water-refrigerant heat exchanger 13, the air-heating expansion valve 14a in the throttled state, the outdoor heat exchanger 15, the air-cooling expansion valve 14b in the throttled state, the indoor evaporator 18, the accumulator 23, and the suction port of the compressor 11 in this order.

In the high-temperature side heat medium circuit 30 in the single dehumidifying and air-heating mode, the control device 60 operates the high-temperature side pump 31 as in the single air-cooling mode.

In the low-temperature side heat medium circuit 40 in the single dehumidifying and air-heating mode, the control device 60 stops the first low-temperature side pump 41a and the second low-temperature side pump 41b as in the single air-cooling mode.

In the indoor air conditioning unit 50 in the single dehumidifying and air-heating mode, the control device 60 controls the rotation speed of the indoor blower 52, the opening of the air mix door 54, and the like as in the single air-cooling mode. In addition, the control device 60 appropriately controls the operations of other control target devices.

Therefore, in the heat pump cycle 10 in the single dehumidifying and air-heating mode, a vapor compression refrigeration cycle is configured in which the water-refrigerant heat exchanger 13 functions as a condenser and the indoor evaporator 18 functions as an evaporator.

In the heat pump cycle 10 in the single dehumidifying and air-heating mode, in a case where the saturation temperature of the refrigerant in the outdoor heat exchanger 15 is higher than the outside air temperature Tam, the outdoor heat exchanger 15 functions as a condenser. In a case where the saturation temperature of the refrigerant in the outdoor heat exchanger 15 is lower than the outside air temperature Tam, the outdoor heat exchanger 15 functions as an evaporator.

In the high-temperature side heat medium circuit 30 in the single dehumidifying and air-heating mode, the high-temperature side heat medium heated by the water-refrigerant heat exchanger 13 flows into the heater core 32 as in the single air-cooling mode.

In the indoor air conditioning unit 50 in the single dehumidifying and air-heating mode, the ventilation air blown from the indoor blower 52 is cooled and dehumidified by the indoor evaporator 18. The ventilation air cooled and dehumidified by the indoor evaporator 18 is reheated by the heater core 32 depending on the opening of the air mix door 54. The ventilation air whose temperature has been adjusted so as to approach the target blowing temperature TAO is blown into the vehicle compartment, so that the vehicle compartment is dehumidified and heated.

(b-2) Cooling and Dehumidifying and Air-Heating Mode

In the heat pump cycle 10 in the cooling and dehumidifying and air-heating mode, the control device 60 brings the cooling expansion valve 14c into the throttled state as compared with the single dehumidifying and air-heating mode.

For this reason, in the heat pump cycle 10 in the cooling and dehumidifying and air-heating mode, the refrigerant discharged from the compressor 11 circulates as in the single dehumidifying and air-heating mode. At the same time, the refrigerant circuit is switched to a refrigerant circuit in which the refrigerant discharged from the compressor 11 circulates through the water-refrigerant heat exchanger 13, the air-heating expansion valve 14a in the throttled state, the outdoor heat exchanger 15, the cooling expansion valve 14c in the throttled state, the chiller 20, the accumulator 23, and the suction port of the compressor 11 in this order. That is, the refrigerant circuit is switched to a refrigerant circuit in which the indoor evaporator 18 and the chiller 20 are connected in parallel to the refrigerant flow.

In the high-temperature side heat medium circuit 30 in the cooling and dehumidifying and air-heating mode, the control device 60 operates the high-temperature side pump 31 as in the single air-cooling mode.

In the low-temperature side heat medium circuit 40 in the cooling and dehumidifying and air-heating mode, the control device 60 controls the operations of the heat medium three-way valve 42, the heat medium four-way valve 43, the first low-temperature side pump 41a, and the second low-temperature side pump 41b as in the cooling and air-cooling mode.

In the indoor air conditioning unit 50 in the cooling and dehumidifying and air-heating mode, the control device 60 controls the rotation speed of the indoor blower 52, the opening of the air mix door 54, and the like as in the single air-cooling mode. In addition, the control device 60 appropriately controls the operations of other control target devices.

Therefore, in the heat pump cycle 10 in the cooling and dehumidifying and air-heating mode, a vapor compression refrigeration cycle is configured in which the water-refrigerant heat exchanger 13 functions as a condenser, and the indoor evaporator 18 and the chiller 20 function as evaporators as in the single dehumidifying and air-heating mode.

In the heat pump cycle 10 in the cooling and dehumidifying and air-heating mode, as in the single dehumidifying and air-heating mode, in a case where the saturation temperature of the refrigerant in the outdoor heat exchanger 15 is higher than the outside air temperature Tam, the outdoor heat exchanger 15 functions as a condenser. In a case where the saturation temperature of the refrigerant in the outdoor heat exchanger 15 is lower than the outside air temperature Tam, the outdoor heat exchanger 15 functions as an evaporator.

In the high-temperature side heat medium circuit 30 in the cooling and dehumidifying and air-heating mode, the high-temperature side heat medium heated by the water-refrigerant heat exchanger 13 flows into the heater core 32 as in the single air-cooling mode.

In the low-temperature side heat medium circuit 40 in the cooling and dehumidifying and air-heating mode, as in the cooling and air-cooling mode, the low-temperature side heat medium cooled by the chiller 20 flows into the cooling water passage 70a of the battery 70 to cool the battery 70.

In the indoor air conditioning unit 50 in the cooling and dehumidifying and air-heating mode, as in the single dehumidifying and air-heating mode, the ventilation air whose temperature has been adjusted is blown into the vehicle compartment, so that the vehicle compartment is dehumidified and heated.

### (c) Outside Air Endothermic and Air-Heating Mode

The outside air endothermic and air-heating mode is an operation mode in which the vehicle compartment is heated by blowing heated ventilation air into the vehicle compartment. The outside air endothermic and air-heating mode tends to be selected when the outside air temperature Tam is relatively low (equal to or higher than −10° C. and lower than 0° C. in the present embodiment) or when the target blowing temperature TAO is a relatively high value in a state where the auto-switch and the air conditioner switch are turned on.

The outside air endothermic and air-heating mode includes a single outside air endothermic and air-heating mode and a cooling and outside air endothermic and air-heating mode. The single outside air endothermic and air-heating mode is an operation mode in which the vehicle compartment is heated without cooling the battery 70. The cooling and outside air endothermic and air-heating mode is an operation mode in which the battery 70 is cooled and at the same time, the vehicle compartment is heated.

(c-1) Single Outside Air Endothermic and Air-Heating Mode

In the heat pump cycle 10 in the single outside air endothermic and air-heating mode, the control device 60 brings the air-heating expansion valve 14a into the throttled state, brings the air-cooling expansion valve 14b into the fully closed state, brings the cooling expansion valve 14c into the fully closed state, and brings the bypass-side flow rate regulating valve 14d into the fully closed state. The control device 60 closes the high-pressure side on-off valve 22a and opens the low-pressure side on-off valve 22b.

Therefore, in the heat pump cycle 10 in the single outside air endothermic and air-heating mode, the refrigerant circuit is switched to a refrigerant circuit in which the refrigerant discharged from the compressor 11 circulates through the water-refrigerant heat exchanger 13, the air-heating expansion valve 14a in the throttled state, the outdoor heat exchanger 15, the low-pressure side passage 21b, the accumulator 23, and the suction port of the compressor 11 in this order.

The control device 60 controls the rotation speed of the compressor 11 within a range not exceeding the upper limit rotation speed Nclmt such that the discharge refrigerant pressure Pd detected by the high-pressure side refrigerant temperature-pressure sensor 62b approaches a target high pressure PDO. The target high pressure PDO is determined on the basis of the target blowing temperature TAO with reference to the control map stored in advance in the control device 60. In the control map, the target high pressure PDO is determined to be increased as the target blowing temperature TAO increases.

In the high-temperature side heat medium circuit 30 in the single outside air endothermic and air-heating mode, the control device 60 operates the high-temperature side pump 31 as in the single air-cooling mode.

In the low-temperature side heat medium circuit 40 in the single outside air endothermic and air-heating mode, the control device 60 stops the first low-temperature side pump 41a and the second low-temperature side pump 41b as in the single air-cooling mode.

In the indoor air conditioning unit 50 in the single outside air endothermic and air-heating mode, the control device 60 controls the rotation speed of the indoor blower 52, the opening of the air mix door 54, and the like as in the single air-cooling mode. In addition, the control device 60 appropriately controls the operations of other control target devices.

Therefore, in the heat pump cycle 10 in the single outside air endothermic and air-heating mode, a vapor compression refrigeration cycle is configured in which the water-refrigerant heat exchanger 13 functions as a condenser and the outdoor heat exchanger 15 functions as an evaporator.

In the high-temperature side heat medium circuit 30 in the single outside air endothermic and air-heating mode, the high-temperature side heat medium heated by the water-refrigerant heat exchanger 13 flows into the heater core 32 as in the single air-cooling mode.

In the indoor air conditioning unit 50 in the single outside air endothermic and air-heating mode, the ventilation air blown from the indoor blower 52 passes through the indoor evaporator 18. The ventilation air having passed through the indoor evaporator 18 is heated by the heater core 32 so as to approach the target blowing temperature TAO depending on the opening of the air mix door 54. The ventilation air whose temperature has been adjusted is blown into the vehicle compartment, so that the vehicle compartment is heated.

(c-2) Cooling and Outside Air Endothermic and Air-Heating Mode

In the heat pump cycle 10 in the cooling and outside air endothermic and air-heating mode, the control device 60 brings the cooling expansion valve 14c into the throttled state as compared with the single outside air endothermic and air-heating mode. The control device 60 opens the high-pressure side on-off valve 22a.

For this reason, in the heat pump cycle 10 in the cooling and outside air endothermic and air-heating mode, the refrigerant discharged from the compressor 11 circulates as in the single outside air endothermic and air-heating mode. At the same time, the refrigerant circuit is switched to a refrigerant circuit in which the refrigerant discharged from the compressor 11 circulates through the water-refrigerant heat exchanger 13, the high-pressure side passage 21a, the cooling expansion valve 14c in the throttled state, the chiller 20, the accumulator 23, and the suction port of the compressor 11 in this order. That is, the refrigerant circuit is switched to a refrigerant circuit in which the outdoor heat exchanger 15 and the chiller 20 are connected in parallel to the refrigerant flow.

In the high-temperature side heat medium circuit 30 in the cooling and outside air endothermic and air-heating mode, the control device 60 operates the high-temperature side pump 31 as in the single air-cooling mode.

In the low-temperature side heat medium circuit 40 in the cooling and outside air endothermic and air-heating mode, the control device 60 controls the operations of the heat medium three-way valve 42, the heat medium four-way valve 43, the first low-temperature side pump 41a, and the second low-temperature side pump 41b as in the cooling and air-cooling mode.

Therefore, in the heat pump cycle 10 in the cooling and outside air endothermic and air-heating mode, a vapor compression refrigeration cycle is configured in which the water-refrigerant heat exchanger 13 functions as a condenser and the outdoor heat exchanger 15 and the chiller 20 function as evaporators.

In the high-temperature side heat medium circuit 30 in the cooling and outside air endothermic and air-heating mode, the high-temperature side heat medium heated by the water-refrigerant heat exchanger 13 flows into the heater core 32 as in the single air-cooling mode.

In the low-temperature side heat medium circuit 40 in the cooling and outside air endothermic and air-heating mode, as in the cooling and air-cooling mode, the low-temperature side heat medium cooled by the chiller 20 flows into the cooling water passage 70a of the battery 70 to cool the battery 70.

In the indoor air conditioning unit 50 in the cooling and outside air endothermic and air-heating mode, as in the single outside air endothermic and air-heating mode, the ventilation air whose temperature has been adjusted is blown into the vehicle compartment, so that the vehicle compartment is heated.

### (d) Hot Gas Air-Heating Mode

The hot gas air-heating mode is an operation mode in which the vehicle compartment is heated with a higher heating capability than in the outside air endothermic and air-heating mode. The hot gas air-heating mode is selected when the outside air temperature Tam is extremely low (lower than −10° C. in the present embodiment) in a state where the auto-switch and the air conditioner switch are turned on or when it is determined that the ventilation air heating capability in the heater core 32 is insufficient during the outside air endothermic and air-heating mode.

In the control program of the present embodiment, it is determined that the ventilation air heating capability is insufficient when the rotation speed of the compressor 11 reaches the upper limit rotation speed Nclmt and the ventilation air temperature TAV is lower than the target blowing temperature TAO during the outside air endothermic and air-heating mode.

In the heat pump cycle 10 in the hot gas air-heating mode, the control device 60 brings the air-heating expansion valve 14a into the fully closed state, brings the air-cooling expansion valve 14b into the fully closed state, brings the cooling expansion valve 14c into the throttled state, and brings the bypass-side flow rate regulating valve 14d into the throttled state. The control device 60 opens the high-pressure side on-off valve 22a and closes the low-pressure side on-off valve 22b.

Therefore, in the heat pump cycle 10 in the hot gas air-heating mode, the refrigerant discharged from the compressor 11 circulates through the first three-way joint 12a, the water-refrigerant heat exchanger 13, the high-pressure side passage 21a, the cooling expansion valve 14c in the throttled state, the chiller 20, the accumulator 23, and the suction port of the compressor 11 in this order. At the same time, the refrigerant circuit is switched to a refrigerant circuit in which the refrigerant discharged from the compressor 11 circulates through the first three-way joint 12a, the bypass-side flow rate regulating valve 14d in the throttled state, which is disposed in the bypass passage 21c, the accumulator 23, and the suction port of the compressor 11 in this order.

The control device 60 controls the rotation speed of the compressor 11 within the range not exceeding the upper limit rotation speed Nclmt such that the suction refrigerant pressure Ps detected by the chiller-side refrigerant temperature-pressure sensor 62e approaches a target low pressure PSO.

Controlling the chiller-side refrigerant pressure Pc corresponding to the suction refrigerant pressure Ps so as to approach a constant pressure is effective for stabilizing a discharge flow rate Gr (mass flow rate) of the compressor 11. More specifically, by using a saturated gas-phase refrigerant with a constant pressure as the suction refrigerant, the density of the suction refrigerant becomes constant. Therefore, when the suction refrigerant pressure Ps is controlled to approach a constant pressure, the discharge flow rate Gr of the compressor 11 at the same rotation speed is easily stabilized.

The control device 60 controls the throttle opening of the bypass-side flow rate regulating valve 14d such that the discharge refrigerant pressure Pd approaches the target high pressure PDO.

The control device 60 controls the throttle opening of the cooling expansion valve 14c such that the refrigerant on the outlet side of the chiller 20 is close to the saturated gas-phase refrigerant.

In the high-temperature side heat medium circuit 30 in the hot gas air-heating mode, the control device 60 operates the high-temperature side pump 31 as in the single air-cooling mode.

In the low-temperature side heat medium circuit 40 in the hot gas air-heating mode, the control device 60 stops the first low-temperature side pump 41a and the second low-temperature side pump 41b as in the single air-cooling mode.

In the indoor air conditioning unit 50 in the hot gas air-heating mode, the control device 60 controls the rotation speed of the indoor blower 52, the opening of the air mix door 54, and the like as in the single air-cooling mode. In the hot gas air-heating mode, the opening of the air mix door 54 is often controlled such that almost the entire volume of ventilation air blown from the indoor blower 52 passes through the heater core 32.

The control device 60 controls the operation of the inside air and outside air switching device 53 so as to introduce inside air into the air conditioning case 51. In addition, the control device 60 appropriately controls the operations of other control target devices.

Therefore, in the heat pump cycle 10 in the hot gas air-heating mode, the flow of the refrigerant discharged from the compressor 11 is branched at the first three-way joint 12a. One refrigerant branched at the first three-way joint 12a flows into the water-refrigerant heat exchanger 13. The refrigerant flowing into the water-refrigerant heat exchanger 13 radiates heat to the high-temperature side heat medium. As a result, the high-temperature side heat medium is heated.

The refrigerant flowing out of the water-refrigerant heat exchanger 13 flows into the high-pressure side passage 21a. The refrigerant flowing into the high-pressure side passage 21a flows into the cooling expansion valve 14c as the heating-unit side decompression unit and is decompressed. The refrigerant with relatively low enthalpy, which is decompressed by the cooling expansion valve 14c, flows into the other inflow port of the sixth three-way joint 12f.

The other refrigerant branched at the first three-way joint 12a flows into the bypass passage 21c. The refrigerant flowing into the bypass passage 21c is subjected to flow rate regulation at the bypass-side flow rate regulating valve 14d to be decompressed. The refrigerant with relatively high enthalpy, which is decompressed by the bypass-side flow rate regulating valve 14d, flows into one inflow port of the sixth three-way joint 12f.

At the sixth three-way joint 12f, the flow of the refrigerant flowing out of the cooling expansion valve 14c and the flow of the refrigerant flowing out of the bypass-side flow rate regulating valve 14d are joined and mixed. The refrigerant flowing out of the sixth three-way joint 12f flows into the chiller 20 and is further homogeneously mixed. In the hot gas air-heating mode, since the first low-temperature side pump 41a and the second low-temperature side pump 41b are stopped, heat exchange is not performed between the refrigerant and the low-temperature side heat medium in the chiller 20.

The refrigerant flowing out of the refrigerant passage of the chiller 20 flows into the accumulator 23. The gas-phase refrigerant separated in the accumulator 23 is drawn into the compressor 11 and compressed again.

In the high-temperature side heat medium circuit 30 in the hot gas air-heating mode, the high-temperature side heat medium heated by the water-refrigerant heat exchanger 13 flows into the heater core 32 as in the single air-cooling mode.

In the indoor air conditioning unit 50 in the hot gas air-heating mode, similarly to the single outside air endothermic and air-heating mode, the ventilation air whose temperature has been adjusted is blown into the vehicle compartment, so that the vehicle compartment is heated.

The hot gas air-heating mode is performed when the outside air temperature Tam is extremely low. For this reason, when the refrigerant flowing out of the water-refrigerant heat exchanger 13 flows into the outdoor heat exchanger 15, the refrigerant may radiate heat to the outside air in outdoor heat exchanger 15. If the refrigerant radiates heat to the outside air in the outdoor heat exchanger 15, the amount of heat radiated from the refrigerant to ventilation air in the water-refrigerant heat exchanger 13 decreases, and the ventilation air heating capability decreases.

On the other hand, in the hot gas air-heating mode, the refrigerant circuit is switched to a refrigerant circuit that does not allow the refrigerant flowing out of the water-refrigerant heat exchanger 13 to flow into the outdoor heat exchanger 15, so that the refrigerant can be reduced or prevented from radiating heat to the outside air in the outdoor heat exchanger 15.

In the hot gas air-heating mode, the throttle opening of the cooling expansion valve 14c is controlled such that the refrigerant on the outlet side of the chiller 20 is close to the saturated gas-phase refrigerant. Accordingly, even when the refrigerant discharge capability of the compressor 11 is increased and the amount of heat radiated from the refrigerant to the high-temperature side heat medium in the water-refrigerant heat exchanger 13 is increased, the suction refrigerant drawn into the compressor 11 can be maintained in an appropriate state. Therefore, the cycle can be stably operated.

As a result, in the hot gas air-heating mode, even when the outside air temperature Tam is extremely low, heat generated by the compression work of the compressor 11 can be effectively used to heat ventilation air, and the vehicle compartment can be heated.

### (e) Endothermic Hot Gas Air-Heating Mode

The endothermic hot gas air-heating mode is an operation mode in which the vehicle compartment is heated with a higher heating capability than in the hot gas air-heating mode. The endothermic hot gas air-heating mode is selected when it is determined that the ventilation air heating capability in the heater core 32 is insufficient and the vehicle compartment can be heated using heat generated by the heat generating unit during the hot gas air-heating mode.

In the control program of the present embodiment, it is determined that the ventilation air heating capability is insufficient when the rotation speed of the compressor 11 reaches the upper limit rotation speed Nclmt and the ventilation air temperature TAV is lower than the target blowing temperature TAO during the hot gas air-heating mode.

When the inflow temperature TWLC detected by the low-temperature side heat medium temperature sensor 63b is equal to or higher than the target heat medium temperature TWLCO during the hot gas air-heating mode, it is determined that the vehicle compartment can be heated using the heat generated by the heat generating unit.

The endothermic hot gas air-heating mode includes a first endothermic hot gas air-heating mode and a second endothermic hot gas air-heating mode.

The first endothermic hot gas air-heating mode is an operation mode in which the vehicle compartment is heated using both heat generated by the heat medium electric heater 44 as the high controllable heat generating unit and heat generated by the battery 70 as the low controllable heat generating unit. The first endothermic hot gas air-heating mode is selected when it is determined that the vehicle compartment can be heated using the heat generated by the battery 70.

The second endothermic hot gas air-heating mode is an operation mode in which the vehicle compartment is heated using only the heat generated by the heat medium electric heater 44. The second endothermic hot gas air-heating mode is selected when it is not determined that the vehicle compartment can be heated using the heat generated by the battery 70.

In the control program of the present embodiment, it is determined that the vehicle compartment can be heated using the heat generated by the battery 70 when the battery temperature TB detected by the battery temperature sensor 64 is equal to or higher than a predetermined reference endothermic temperature KTB2. The reference endothermic temperature KTB2 is set to a value lower than the reference cooling temperature KTB1 and the target heat medium temperature TWLCO.

(e-1) First Endothermic Hot Gas Air-Heating Mode

In the heat pump cycle 10 in the first endothermic hot gas air-heating mode, as in the hot gas air-heating mode, the control device 60 controls the operations of the air-heating expansion valve 14a, the air-cooling expansion valve 14b, the cooling expansion valve 14c, the bypass-side flow rate regulating valve 14d, the high-pressure side on-off valve 22a, and the low-pressure side on-off valve 22b.

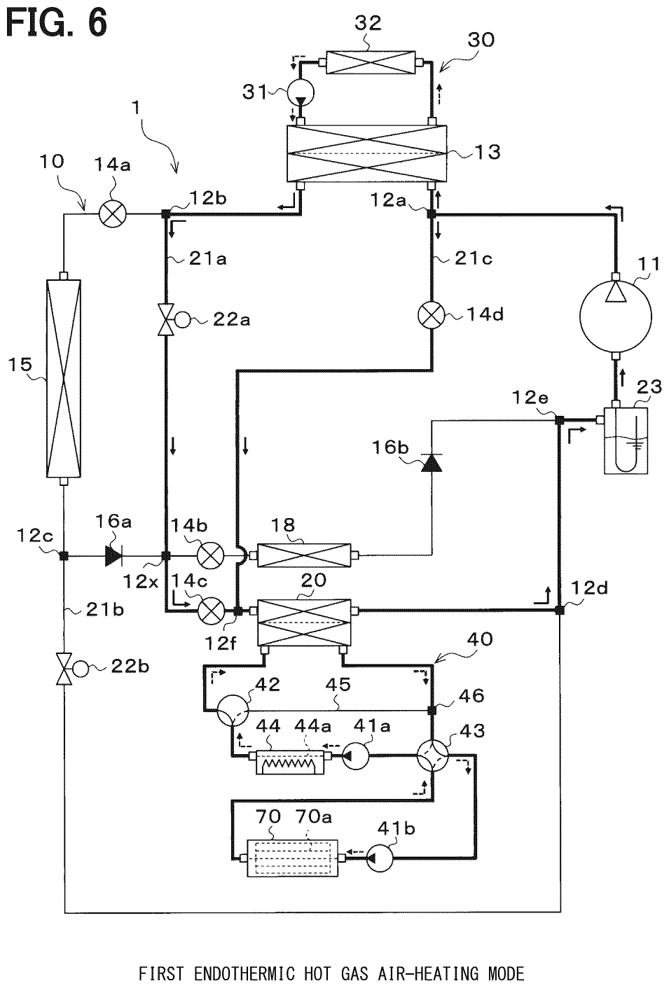

For this reason, in the heat pump cycle 10 in the first hot gas air-heating mode, the refrigerant discharged from the compressor 11 circulates as in the hot gas air-heating mode, as indicated by solid arrows in FIG. 6.

In the high-temperature side heat medium circuit 30 in the first endothermic hot gas air-heating mode, the control device 60 operates the high-temperature side pump 31 as in the single air-cooling mode. Therefore, in the high-temperature side heat medium circuit 30 in the first endothermic hot gas air-heating mode, the high-temperature side heat medium pumped from the high-temperature side pump 31 circulates as in the single air-cooling mode, as indicated by broken arrows in FIG. 6.

In the low-temperature side heat medium circuit 40 in the first endothermic hot gas air-heating mode, the control device 60 controls the operation of the heat medium three-way valve 42 so as to connect the outlet side of the heating passage 44a in the heat medium electric heater 44 and the inlet side of the heat medium passage in the chiller 20, similarly to the cooling and air-cooling mode.

The control device 60 controls the operation of the heat medium four-way valve 43 so as to connect the outflow port side of the heat medium three-way joint 46 and the suction port side of the second low-temperature side pump 41b, and at the same time, connect the outlet side of the cooling water passage 70a in the battery 70 and the suction port side of the first low-temperature side pump 41a.

The control device 60 operates the first low-temperature side pump 41a and the second low-temperature side pump 41b. In the first endothermic hot gas air-heating mode, the rotation speeds of the first low-temperature side pump 41a and the second low-temperature side pump 41b are increased as the inflow temperature TWLC increases. That is, as the inflow temperature TWLC increases, the inflow rate of the heat medium flowing into the heat medium passage of the chiller 20 is increased.

In addition, the control device 60 supplies electric power to the heat medium electric heater 44 such that the inflow temperature TWLC is equal to or higher than the target heat medium temperature TWLCO.

Therefore, in the low-temperature side heat medium circuit 40 in the first endothermic hot gas air-heating mode, the low-temperature side heat medium pumped from the first low-temperature side pump 41a flows through the heating passage 44a of the heat medium electric heater 44, the heat medium three-way valve 42, the heat medium passage of the chiller 20, the heat medium four-way valve 43, and the suction port of the second low-temperature side pump 41b in this order, as indicated by broken arrows in FIG. 6. In addition, the low-temperature side heat medium pumped from the second low-temperature side pump 41b flows through the cooling water passage 70a of the battery 70, the heat medium four-way valve 43, and the suction port of the first low-temperature side pump 41a in this order.

In the indoor air conditioning unit 50 in the first endothermic hot gas air-heating mode, the control device 60 controls the rotation speed of the indoor blower 52, the opening of the air mix door 54, and the like as in the single air-cooling mode. In addition, the control device 60 appropriately controls the operations of other control target devices.

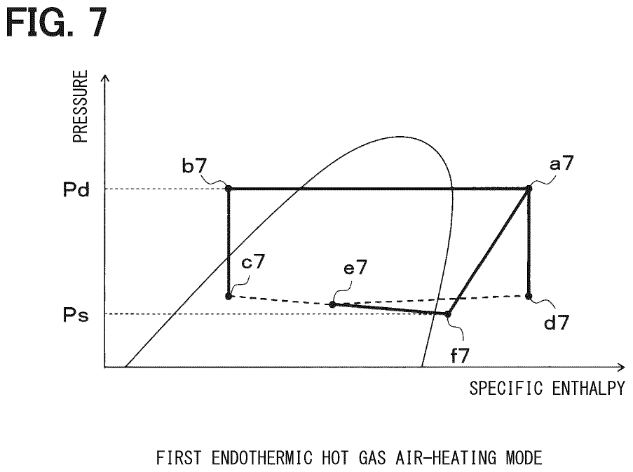

Therefore, in the heat pump cycle 10 in the first endothermic hot gas air-heating mode, the state of the refrigerant changes as illustrated in the Mollier diagram of FIG. 7.

First, the flow of the discharge refrigerant (point a7 in FIG. 7) discharged from the compressor 11 is branched at the first three-way joint 12a. One refrigerant branched at the first three-way joint 12a flows into the water-refrigerant heat exchanger 13, and radiates heat to the high-temperature side heat medium to reduce enthalpy (from point a7 to point b7 in FIG. 7). As a result, the high-temperature side heat medium is heated.

The refrigerant flowing out of the water-refrigerant heat exchanger 13 flows into the high-pressure side passage 21a. The refrigerant flowing into the high-pressure side passage 21a flows into the cooling expansion valve 14c as the heating-unit side decompression unit and is decompressed (from point b7 to point c7 in FIG. 7). The refrigerant with relatively low enthalpy, which is decompressed by the cooling expansion valve 14c, flows into the other inflow port of the sixth three-way joint 12f.

The other refrigerant branched at the first three-way joint 12a flows into the bypass passage 21c. The refrigerant flowing into the bypass passage 21c is subjected to flow rate regulation at the bypass-side flow rate regulating valve 14d to be decompressed (from point a7 to point d7 in FIG. 7). The refrigerant with relatively high enthalpy, which is decompressed by the bypass-side flow rate regulating valve 14d, flows into one inflow port of the sixth three-way joint 12f.

At the sixth three-way joint 12f, the flow of the refrigerant flowing out of the cooling expansion valve 14c and the flow of the refrigerant flowing out of the bypass-side flow rate regulating valve 14d are joined and mixed (from point c7 to point e7 and from point d7 to point e7 in FIG. 7). The refrigerant flowing out of the sixth three-way joint 12f flows into the chiller 20 and is further homogeneously mixed.

The refrigerant flowing into the chiller 20 absorbs heat from the low-temperature side heat medium to increase enthalpy. The refrigerant flowing out of the refrigerant passage of the chiller 20 flows into the accumulator 23. The gas-phase refrigerant (point f7 in FIG. 7) separated in the accumulator 23 is drawn into the compressor 11 and compressed again.

In the high-temperature side heat medium circuit 30 in the first endothermic hot gas air-heating mode, the high-temperature side heat medium heated by the water-refrigerant heat exchanger 13 flows into the heater core 32 as in the single air-cooling mode.

In the low-temperature side heat medium circuit 40 in the first endothermic hot gas air-heating mode, the low-temperature side heat medium pumped from the first low-temperature side pump 41a is heated to rise in temperature when flowing through the heating passage 44a of the heat medium electric heater 44. The low-temperature side heat medium flowing out of the heating passage 44a flows into the heat medium passage of the chiller 20 via the heat medium three-way valve 42.

The low-temperature side heat medium flowing into the heat medium passage of the chiller 20 is heat-absorbed by the low-pressure refrigerant flowing through the refrigerant passage to be cooled. The low-temperature side heat medium flowing out of the heat medium passage of the chiller 20 is drawn into the second low-temperature side pump 41b via the heat medium four-way valve 43.

The low-temperature side heat medium pumped from the second low-temperature side pump 41b absorbs the heat generated by the battery 70 to rise in temperature when flowing through the cooling water passage 70a of the battery 70. The low-temperature side heat medium flowing out of the cooling water passage 70a of the battery 70 is drawn into the first low-temperature side pump 41a via the heat medium four-way valve 43.

That is, in the low-temperature side heat medium circuit 40 in the first endothermic hot gas air-heating mode, the low-temperature side heat medium heated when flowing through the cooling water passage 70a is heated by the heat medium electric heater 44. The low-temperature side heat medium heated by the heat medium electric heater 44 then flows into the chiller 20.

In the indoor air conditioning unit 50 in the first endothermic hot gas air-heating mode, as in the hot gas air-heating mode, the ventilation air whose temperature has been adjusted is blown into the vehicle compartment, so that the vehicle compartment is heated.

In the first endothermic hot gas air-heating mode, the heat generated by the heat medium electric heater 44 and the battery 70 as heat generating units can be used to heat ventilation air. Therefore, the vehicle compartment can be heated with a higher heating capability than in the hot gas air-heating mode without increasing the rotation speed of the compressor 11.

(e-2) Second Endothermic Hot Gas Air-Heating Mode

In the heat pump cycle 10 in the second endothermic hot gas air-heating mode, as in the first hot gas air-heating mode, the control device 60 controls the operations of the air-heating expansion valve 14a, the air-cooling expansion valve 14b, the cooling expansion valve 14c, the bypass-side flow rate regulating valve 14d, the high-pressure side on-off valve 22a, and the low-pressure side on-off valve 22b.

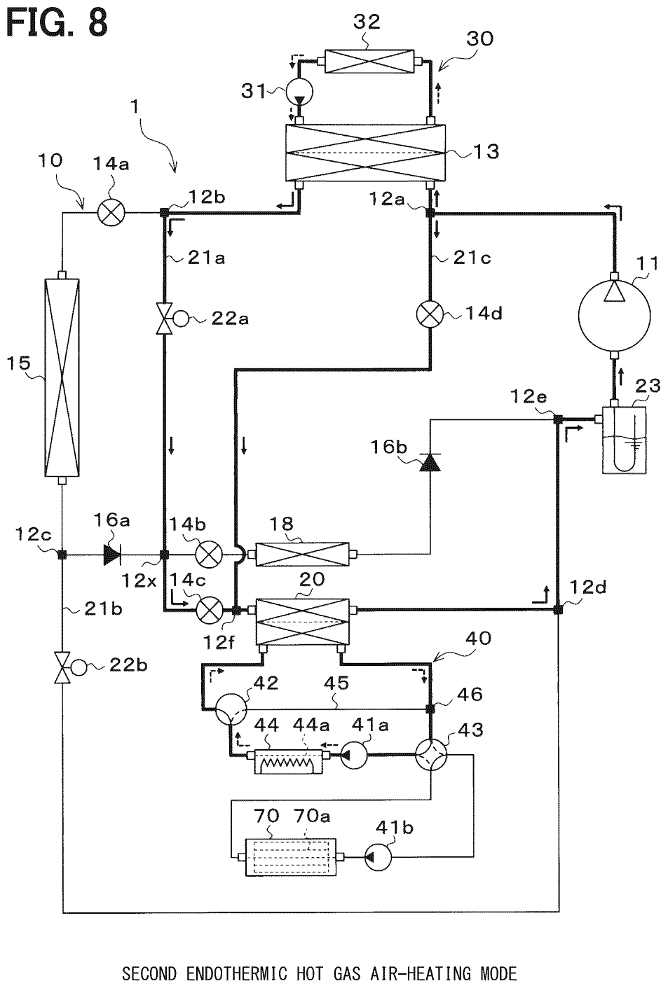

For this reason, in the heat pump cycle 10 in the second endothermic hot gas air-heating mode, the refrigerant discharged from the compressor 11 circulates as in the hot gas air-heating mode, as indicated by solid arrows in FIG. 8.

In the high-temperature side heat medium circuit 30 in the second endothermic hot gas air-heating mode, the control device 60 operates the high-temperature side pump 31 as in the single air-cooling mode. Therefore, in the high-temperature side heat medium circuit 30 in the second endothermic hot gas air-heating mode, the high-temperature side heat medium pumped from the high-temperature side pump 31 circulates as in the single air-cooling mode, as indicated by broken arrows in FIG. 8.

In the low-temperature side heat medium circuit 40 in the second endothermic hot gas air-heating mode, the control device 60 controls the operation of the heat medium three-way valve 42 so as to connect the outlet side of the heating passage 44a in the heat medium electric heater 44 and the inlet side of the heat medium passage in the chiller 20.

The control device 60 controls the operation of the heat medium four-way valve 43 so as to connect the outflow port side of the heat medium three-way joint 46 and the suction port side of the first low-temperature side pump 41a, and at the same time, connect the outlet side of the cooling water passage 70a in the battery 70 and the suction port side of the second low-temperature side pump 41b.

In addition, the control device 60 operates at least the first low-temperature side pump 41a. In the second endothermic hot gas air-heating mode, at least the rotation speed of the first low-temperature side pump 41a is increased as the inflow temperature TWLC increases. That is, the inflow rate is increased as the inflow temperature TWLC increases.

The control device 60 supplies electric power to the heat medium electric heater 44 as in the first endothermic hot gas air-heating mode.

Therefore, in the low-temperature side heat medium circuit 40 in the second endothermic hot gas air-heating mode, the low-temperature side heat medium pumped from the first low-temperature side pump 41a flows through the heating passage 44a of the heat medium electric heater 44, the heat medium passage of the chiller 20, and the suction port of the first low-temperature side pump 41a in this order, as indicated by broken arrows in FIG. 8.

In the indoor air conditioning unit 50 in the second endothermic hot gas air-heating mode, the control device 60 controls the rotation speed of the indoor blower 52, the opening of the air mix door 54, and the like as in the single air-cooling mode. In addition, the control device 60 appropriately controls the operations of other control target devices.

Therefore, in the heat pump cycle 10 in the second endothermic hot gas air-heating mode, the high-temperature side heat medium is heated as in the first endothermic hot gas air-heating mode.

In the high-temperature side heat medium circuit 30 in the second endothermic hot gas air-heating mode, the high-temperature side heat medium heated by the water-refrigerant heat exchanger 13 flows into the heater core 32 as in the single air-cooling mode.

In the low-temperature side heat medium circuit 40 in the second endothermic hot gas air-heating mode, the low-temperature side heat medium pumped from the first low-temperature side pump 41a flows into the heating passage 44a of the heat medium electric heater 44. The low-temperature side heat medium flowing into the heating passage 44a is heated and rises in temperature when flowing through the heating passage 44a. The low-temperature side heat medium flowing out of the heating passage 44a flows into the heat medium passage of the chiller 20 via the heat medium three-way valve 42.

The low-temperature side heat medium flowing into the heat medium passage of the chiller 20 is heat-absorbed by the low-pressure refrigerant flowing through the refrigerant passage to be cooled. The low-temperature side heat medium flowing out of the heat medium passage of the chiller 20 is drawn into the first low-temperature side pump 41a via the heat medium four-way valve 43. That is, in the low-temperature side heat medium circuit 40 in the second endothermic hot gas air-heating mode, the low-temperature side heat medium heated by the heat medium electric heater 44 flows into the chiller 20.

In the indoor air conditioning unit 50 in the second endothermic hot gas air-heating mode, as in the hot gas air-heating mode, the ventilation air whose temperature has been adjusted is blown into the vehicle compartment, so that the vehicle compartment is heated.

In the second endothermic hot gas air-heating mode, the heat generated by the heat medium electric heater 44 as the heat generating unit can be used to heat ventilation air. Therefore, the vehicle compartment can be heated with a higher heating capability than in the hot gas air-heating mode without increasing the rotation speed of the compressor 11.

Furthermore, in the second endothermic hot gas air-heating mode, the low-temperature side heat medium heated by the heat medium electric heater 44 does not flow into the cooling water passage 70a of the battery 70. As a result, it is possible to reduce or prevent the heat generated by the heat medium electric heater 44 from being absorbed by the battery 70 with a large heat capacity.

### (f) Endothermic Hot Gas Air-Heating Preparing Mode

The endothermic hot gas air-heating preparing mode is an operation mode of increasing the inflow temperature TWLC. The endothermic hot gas air-heating preparing mode is selected when the inflow temperature TWLC is lower than the target heat medium temperature TWLCO and the endothermic hot gas air-heating mode cannot be performed even if it is determined that the ventilation air heating capability in the heater core 32 is insufficient during the hot gas air-heating mode.

The endothermic hot gas air-heating preparing mode includes a first endothermic hot gas air-heating preparing mode and a second endothermic hot gas air-heating preparing mode.

The first endothermic hot gas air-heating preparing mode is an operation mode in which the inflow temperature TWLC is increased using both the heat generated by the heat medium electric heater 44 and the heat generated by the battery 70. The first endothermic hot gas air-heating preparing mode is selected when it is determined that the heat generated by the battery 70 can be used to increase the inflow temperature TWLC.

The second endothermic hot gas air-heating preparing mode is an operation mode in which the inflow temperature TWLC is increased using only the heat generated by the heat medium electric heater 44. The second endothermic hot gas air-heating preparing mode is selected when it is not determined that the heat generated by the battery 70 can be used to increase the inflow temperature TWLC.

In the control program of the present embodiment, it is determined that the heat generated by the battery 70 can be used to increase the inflow temperature TWLC when the battery temperature TB detected by the battery temperature sensor 64 is equal to or higher than a predetermined reference endothermic temperature KTB2.

(f-1) First Endothermic Hot Gas Air-Heating Preparing Mode

In the heat pump cycle 10 in the first endothermic hot gas air-heating preparing mode, as in the hot gas air-heating mode, the control device 60 controls the operations of the air-heating expansion valve 14a, the air-cooling expansion valve 14b, the cooling expansion valve 14c, the bypass-side flow rate regulating valve 14d, the high-pressure side on-off valve 22a, and the low-pressure side on-off valve 22b.

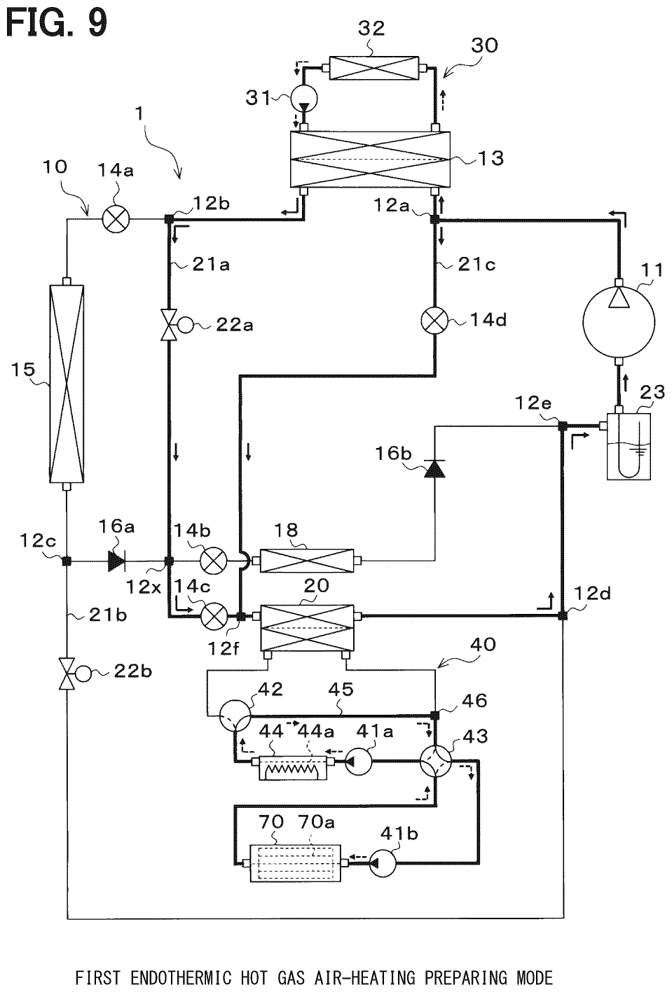

For this reason, in the heat pump cycle 10 in the first endothermic hot gas air-heating preparing mode, the refrigerant discharged from the compressor 11 circulates as in the hot gas air-heating mode, as indicated by solid arrows in FIG. 9.

In the high-temperature side heat medium circuit 30 in the first endothermic hot gas air-heating preparing mode, the control device 60 operates the high-temperature side pump 31 as in the single air-cooling mode. Therefore, in the high-temperature side heat medium circuit 30 in the first endothermic hot gas air-heating preparing mode, the high-temperature side heat medium pumped from the high-temperature side pump 31 circulates as in the single air-cooling mode, as indicated by broken arrows in FIG. 9.

In the low-temperature side heat medium circuit 40 in the first endothermic hot gas air-heating preparing mode, the control device 60 controls the operation of the heat medium three-way valve 42 so as to connect the outlet side of the heating passage 44a in the heat medium electric heater 44 and the inlet side of the heat medium bypass passage 45.

The control device 60 controls the operation of the heat medium four-way valve 43 so as to connect the outflow port side of the heat medium three-way joint 46 and the suction port side of the second low-temperature side pump 41b, and at the same time, connect the outlet side of the cooling water passage 70a in the battery 70 and the suction port side of the first low-temperature side pump 41a.

In addition, the control device 60 operates the first low-temperature side pump 41a and the second low-temperature side pump 41b so as to exhibit a predetermined pumping capability.

In addition, the control device 60 supplies electric power to the heat medium electric heater 44 such that the inflow temperature TWLC is equal to or higher than the target heat medium temperature TWLCO.

Therefore, in the low-temperature side heat medium circuit 40 in the first endothermic hot gas air-heating preparing mode, the low-temperature side heat medium pumped from the first low-temperature side pump 41a and the second low-temperature side pump 41b flows through the heating passage 44a of the heat medium electric heater 44, the heat medium three-way valve 42, the heat medium bypass passage 45, the heat medium four-way valve 43, and the suction port of the second low-temperature side pump 41b in this order, as indicated by broken arrows in FIG. 9. In addition, the low-temperature side heat medium pumped from the second low-temperature side pump 41b flows through the cooling water passage 70a of the battery 70, the heat medium four-way valve 43, and the suction port of the first low-temperature side pump 41a in this order.

In the indoor air conditioning unit 50 in the first endothermic hot gas air-heating preparing mode, the control device 60 controls the rotation speed of the indoor blower 52, the opening of the air mix door 54, and the like as in the single air-cooling mode. In addition, the control device 60 appropriately controls the operations of other control target devices.

Therefore, in the heat pump cycle 10 in the first endothermic hot gas air-heating preparing mode, the state of the refrigerant changes as in the hot gas air-heating mode.

In the high-temperature side heat medium circuit 30 in the first endothermic hot gas air-heating preparing mode, the high-temperature side heat medium heated by the water-refrigerant heat exchanger 13 flows into the heater core 32 as in the single air-cooling mode.

In the low-temperature side heat medium circuit 40 in the first endothermic hot gas air-heating preparing mode, the low-temperature side heat medium pumped from the first low-temperature side pump 41a is heated to rise in temperature when flowing through the heating passage 44a of the heat medium electric heater 44. The low-temperature side heat medium flowing out of the heating passage 44a is drawn into the second low-temperature side pump 41b via the heat medium three-way valve 42, the heat medium bypass passage 45, and the heat medium four-way valve 43.

The low-temperature side heat medium pumped from the second low-temperature side pump 41b absorbs the heat generated by the battery 70 to rise in temperature when flowing through the cooling water passage 70a of the battery 70. The low-temperature side heat medium flowing out of the cooling water passage 70a of the battery 70 is drawn into the first low-temperature side pump 41a via the heat medium four-way valve 43. As a result, the low-temperature side heat medium rises in temperature such that the inflow temperature TWLC is equal to or higher than the target heat medium temperature TWLCO.

In the indoor air conditioning unit 50 in the first endothermic hot gas air-heating preparing mode, as in the hot gas air-heating mode, the ventilation air whose temperature has been adjusted is blown into the vehicle compartment.

Therefore, in the first endothermic hot gas air-heating preparing mode, the inflow temperature TWLC can be increased to quickly shift to the first endothermic hot gas air-heating mode. Although the ventilation air heating capability is insufficient, air-heating equivalent to that in the hot gas air-heating mode can be continued.

(f-2) Second Endothermic Hot Gas Air-Heating Preparing Mode

In the heat pump cycle 10 in the second hot gas air-heating preparing mode, as in the hot gas air-heating mode, the control device 60 controls the operations of the air-heating expansion valve 14a, the air-cooling expansion valve 14b, the cooling expansion valve 14c, the bypass-side flow rate regulating valve 14d, the high-pressure side on-off valve 22a, and the low-pressure side on-off valve 22b.

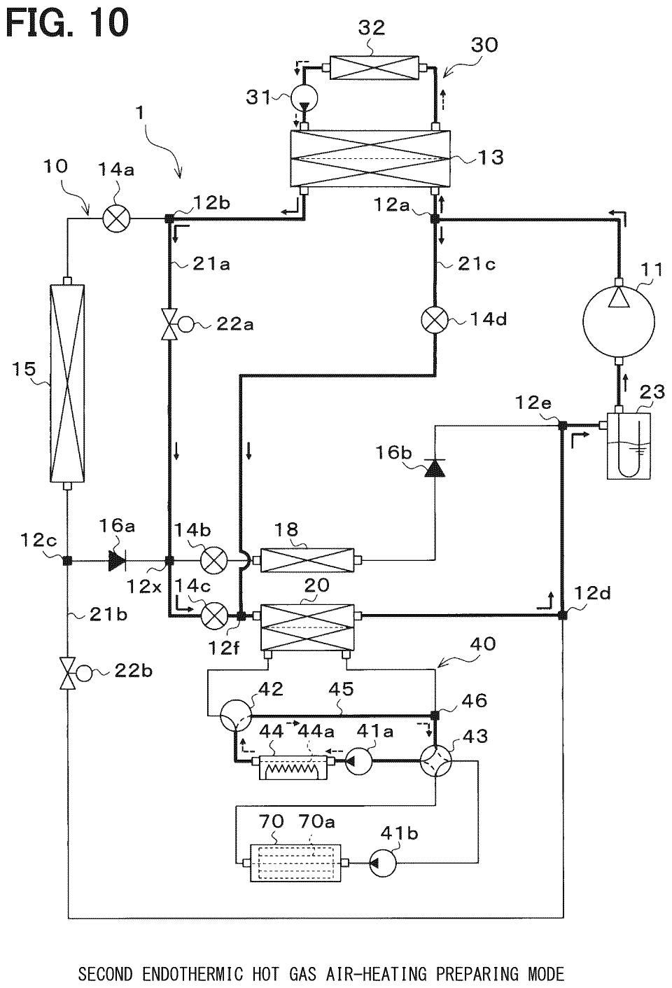

For this reason, in the heat pump cycle 10 in the second hot gas air-heating preparing mode, the refrigerant discharged from the compressor 11 circulates as in the hot gas air-heating mode, as indicated by solid arrows in FIG. 10.

In the high-temperature side heat medium circuit 30 in the second hot gas air-heating preparing mode, the control device 60 operates the high-temperature side pump 31 as in the single air-cooling mode. Therefore, in the high-temperature side heat medium circuit 30 in the second endothermic hot gas air-heating preparing mode, the high-temperature side heat medium pumped from the high-temperature side pump 31 circulates as in the single air-cooling mode, as indicated by broken arrows in FIG. 10.

In the low-temperature side heat medium circuit 40 in the second hot gas air-heating preparing mode, the control device 60 controls the operation of the heat medium three-way valve 42 so as to connect the outlet side of the heating passage 44a in the heat medium electric heater 44 and the inlet side of the heat medium bypass passage 45.

The control device 60 controls the operation of the heat medium four-way valve 43 so as to connect the outflow port side of the heat medium three-way joint 46 and the suction port side of the first low-temperature side pump 41a, and at the same time, connect the outlet side of the cooling water passage 70a in the battery 70 and the suction port side of the second low-temperature side pump 41b.

The control device 60 operates at least the first low-temperature side pump 41a so as to exhibit a predetermined pumping capability.

The control device 60 supplies electric power to the heat medium electric heater 44 as in the second endothermic hot gas air-heating preparing mode.

Therefore, in the low-temperature side heat medium circuit 40 in the second endothermic hot gas air-heating preparing mode, the low-temperature side heat medium pumped from the first low-temperature side pump 41a circulates as indicated by broken arrows in FIG. 10.

As a result, in the heat pump cycle 10 in the second endothermic hot gas air-heating preparing mode, the state of the refrigerant changes as in the hot gas air-heating mode.

In the high-temperature side heat medium circuit 30 in the second endothermic hot gas air-heating preparing mode, the high-temperature side heat medium heated by the water-refrigerant heat exchanger 13 flows into the heater core 32 as in the single air-cooling mode.

In the low-temperature side heat medium circuit 40 in the second endothermic hot gas air-heating preparing mode, the low-temperature side heat medium pumped from the first low-temperature side pump 41a is heated to rise in temperature when flowing through the heating passage 44a of the heat medium electric heater 44. The low-temperature side heat medium flowing out of the heating passage 44a is drawn into the first low-temperature side pump 41a via the heat medium three-way valve 42 and the heat medium four-way valve 43. As a result, the low-temperature side heat medium rises in temperature such that the inflow temperature TWLC is equal to or higher than the target heat medium temperature TWLCO.

In the indoor air conditioning unit 50 in the second endothermic hot gas air-heating preparing mode, as in the hot gas air-heating mode, the ventilation air whose temperature has been adjusted is blown into the vehicle compartment.

Therefore, in the second endothermic hot gas air-heating preparing mode, the inflow temperature TWLC can be increased to quickly shift to the second endothermic hot gas air-heating mode. Although the ventilation air heating capability is insufficient, air-heating equivalent to that in the hot gas air-heating mode can be continued.

As described above, in the vehicle air conditioner 1 of the present embodiment, comfortable air conditioning in the vehicle compartment and appropriate temperature adjustment of the battery 70, which is an in-vehicle device, can be performed by switching the operation mode.

In the compressor 11 of the heat pump cycle 10, the upper limit rotation speed Nclmt determined from the durability of the compressor 11 and noise allowed for the compressor 11 is set. For this reason, in the operation mode in which the vehicle compartment is heated using the heat generated by the compression work of the compressor 11 as in the hot gas air-heating mode, when the rotation speed of the compressor 11 reaches the upper limit rotation speed Nclmt, the ventilation air heating capability cannot be improved.

In contrast, the vehicle air conditioner 1 of the present embodiment can perform the endothermic hot gas air-heating mode. In the endothermic hot gas air-heating mode, in the chiller 20, the low-pressure refrigerant decompressed at the cooling expansion valve 14c absorbs the heat generated by the heat medium electric heater 44 and the battery 70 as heat generating units via the low-temperature side heat medium.

Therefore, by increasing the amount of heat absorbed by the low-pressure refrigerant, the amount of heat radiated from the refrigerant to the high-temperature side heat medium can be increased without increasing the rotation speed of the compressor 11. As a result, in the endothermic hot gas air-heating mode, the ventilation air heating capability can be improved without increasing the rotation speed of the compressor 11, as compared with the hot gas air-heating mode.

In the endothermic hot gas air-heating mode, the low-pressure refrigerant absorbs the heat generated by the heat generating unit. Accordingly, the temperature of the heat generating unit can be made lower than the case where the high-temperature side heat medium or the ventilation air is directly heated by the heat generated by the heat generating unit. As a result, even the heat generated by the low controllable heat generating unit whose amount of heat generated is less easily adjusted than the high controllable heat generating unit is easily used to heat the ventilation air.

In the vehicle air conditioner 1 of the present embodiment, when the inflow temperature TWLC of the low-temperature side heat medium is equal to or higher than the target heat medium temperature TWLCO, the circuit configuration of the low-temperature side heat medium circuit 40 is switched such that the low-temperature side heat medium flows into the chiller 20. That is, when the inflow temperature TWLC of the low-temperature side heat medium is equal to or higher than the target heat medium temperature TWLCO, the endothermic hot gas air-heating mode is performed.

Accordingly, the heat generated by the heat medium electric heater 44 and the battery 70 as heat generating units can be reliably absorbed by the low-pressure refrigerant via the low-temperature side heat medium. That is, the ventilation air heating capability can be reliably improved.

In the vehicle air conditioner 1 of the present embodiment, in the first endothermic hot gas air-heating mode, the low-temperature side heat medium heated by the battery 70 as the low controllable heat generating unit is heated by the heat medium electric heater 44 as the high controllable heat generating unit. The circuit configuration of the low-temperature side heat medium circuit 40 is switched such that the low-temperature side heat medium heated by the heat medium electric heater 44 flows into the heat medium circuit of the chiller 20.

That is, in the first endothermic hot gas air-heating mode, the circuit configuration of the low-temperature side heat medium circuit 40 is switched such that the low-temperature side heat medium flows through the cooling water passage 70a of the battery 70, the heating passage 44a of the heat medium electric heater 44, and the heat medium passage of the chiller 20 in this order. Accordingly, the amount of heat generated by the high controllable heat generating unit can be appropriately controlled depending on the amount of heat generated by the low controllable heat generating unit.

For example, in a case where the temperature of the low-temperature side heat medium heated in the cooling water passage 70a of the battery 70 is lower than the target heat medium temperature TWLCO, electric power may be supplied to the heat medium electric heater 44 such that the inflow temperature TWLC is equal to or higher than the target heat medium temperature TWLCO.

In a case where the temperature of the low-temperature side heat medium heated in the cooling water passage 70a of the battery 70 is equal to or higher than the target heat medium temperature TWLCO, the supply of electric power to the heat medium electric heater 44 may be stopped. As a result, unnecessary power consumption can be reduced or prevented.

In the vehicle air conditioner 1 of the present embodiment, the first endothermic hot gas air-heating mode and the second endothermic hot gas air-heating mode are switched depending on the battery temperature TB of the battery 70 as the low controllable heat generating unit. Accordingly, it is possible to appropriately determine whether or not the heat generated by the low controllable heat generating unit can be used to heat ventilation air, and to effectively use the heat generated by the low controllable heat generating unit and the heat generated by the high controllable heat generating unit.

In the vehicle air conditioner 1 of the present embodiment, the target heat medium temperature TWLCO is increased as the upper limit rotation speed Nclmt decreases. Accordingly, in the endothermic hot gas air-heating mode, the amount of heat generated by the high controllable heat generating unit can be more appropriately controlled based on the compression workload that can be exhibited by the compressor 11.

In the vehicle air conditioner 1 of the present embodiment, the low-temperature side heat medium circuit 40 includes the heat medium bypass passage 45. When the inflow temperature TWLC is equal to or lower than the target heat medium temperature TWLCO, the endothermic hot gas air-heating preparing mode is performed. Accordingly, even when the ventilation air heating capability is insufficient during the hot gas air-heating mode, the inflow temperature TWLC can be rapidly increased to shift to the endothermic hot gas air-heating mode.

In the vehicle air conditioner 1 of the present embodiment, the first endothermic hot gas air-heating preparing mode and the second endothermic hot gas air-heating preparing mode are switched depending on the battery temperature TB of the battery 70 as the low controllable heat generating unit. Accordingly, it is possible to appropriately determine whether or not the heat generated by the low controllable heat generating unit can be used to increase the inflow temperature TWLC, and to effectively use the heat generated by the low controllable heat generating unit and the heat generated by the high controllable heat generating unit.

### Second Embodiment

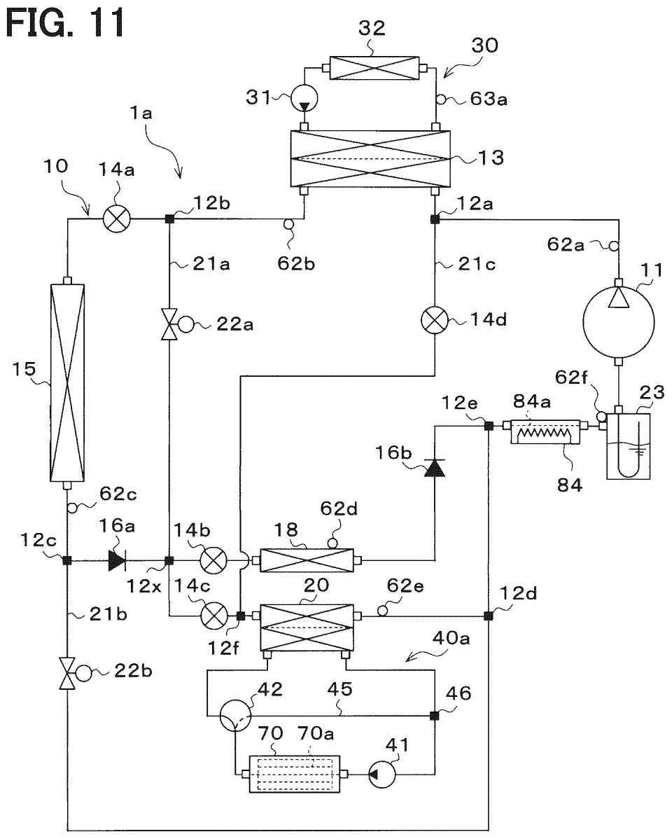

In the present embodiment, the heat pump cycle device according to the present disclosure is applied to a vehicle air conditioner 1a illustrated in an overall configuration diagram of FIG. 11. The vehicle air conditioner 1a is an air conditioner with an in-vehicle device temperature adjustment function similar to that of the first embodiment.

In the heat pump cycle 10 of the vehicle air conditioner 1a, a heating passage 84a of a refrigerant electric heater 84 is disposed in a refrigerant passage from the outflow port of the fifth three-way joint 12e to the inlet port of the accumulator 23. The basic configuration of the refrigerant electric heater 84 is similar to the heat medium electric heater 44 described in the first embodiment.

Therefore, the refrigerant electric heater 84 is a high controllable heat generating unit. The heating passage 84a of the refrigerant electric heater 84 is a endothermic unit. More specifically, the chiller 20 of the first embodiment is a endothermic unit that causes a low-pressure refrigerant to indirectly absorb heat generated by the heat medium electric heater 44 via a low-temperature side heat medium. On the other hand, the heating passage 84a of the present embodiment is a endothermic unit that causes the low-pressure refrigerant to directly absorb the heat generated by the refrigerant electric heater 84.

In the vehicle air conditioner 1a, a low-temperature side heat medium circuit 40a is used instead of the low-temperature side heat medium circuit 40 described in the first embodiment.

In the low-temperature side heat medium circuit 40a, the first low-temperature side pump 41a, the heat medium three-way valve 42, and the heat medium electric heater 44 are eliminated. In the low-temperature side heat medium circuit 40a, the low-temperature side pump 41, the heat medium three-way valve 42, the heat medium bypass passage 45, the cooling water passage 70a of the battery 70, the heat medium passage of the chiller 20, and the like are arranged. The low-temperature side pump 41 is a low-temperature side heat medium pumping unit corresponding to the second low-temperature side pump 41b of the first embodiment.

In the low-temperature side heat medium circuit 40a, the inflow port side of the heat medium three-way valve 42 is connected to the outlet port of the cooling water passage 70a in the battery 70. The suction port side of the low-temperature side pump 41 is connected to the outflow port of the heat medium three-way joint 46.

A suction refrigerant temperature sensor 62f is connected to the input side of the control device 60 in the vehicle air conditioner 1a. The suction refrigerant temperature sensor 62f is a suction refrigerant temperature detecting unit that detects a suction refrigerant temperature Ts that is the temperature of the suction refrigerant drawn into the compressor 11. Specifically, the suction refrigerant temperature sensor 62f detects the temperature of the refrigerant at the inlet port portion of the accumulator 23. Other configurations are similar to those of the vehicle air conditioner 1 described in the first embodiment.

Next, the operation of the vehicle air conditioner 1a of the present embodiment with the above configuration will be described. The vehicle air conditioner 1a can perform (a) air-cooling mode, (b) dehumidifying and air-heating mode, (c) outside air endothermic and air-heating mode, and (d) hot gas air-heating mode, as in the vehicle air conditioner 1 described in the first embodiment.

In the above operation modes, when the battery 70 is cooled, the control device 60 controls the operation of the heat medium three-way valve 42 so as to connect the outlet side of the cooling water passage 70a in the battery 70 and the inlet side of the heat medium passage in the chiller 20. Furthermore, the low-temperature side pump 41 is operated so as to exhibit a predetermined pumping capability.

### (e) Endothermic Hot Gas Air-Heating Mode

The endothermic hot gas air-heating mode of the present embodiment is selected when it is determined that the ventilation air heating capability in the heater core 32 is insufficient during the hot gas air-heating mode.

(e-1) First Endothermic Hot Gas Air-Heating Mode

In the heat pump cycle 10 in the first endothermic hot gas air-heating mode, the control device 60 supplies electric power to the refrigerant electric heater 84.

In the low-temperature side heat medium circuit 40a in the first endothermic hot gas air-heating mode, the control device 60 controls the operation of the heat medium three-way valve 42 so as to connect the outlet side of the cooling water passage 70a in the battery 70 and the inlet side of the heat medium passage in the chiller 20.

In the low-temperature side heat medium circuit 40a, the low-temperature side heat medium pumped from the low-temperature side pump 41 circulates through the cooling water passage 70a of the battery 70, the heat medium passage of the chiller 20, and the suction port of the low-temperature side pump 41 in this order. Other operations are similar to those of the first embodiment.

Therefore, in the heat pump cycle 10 in the first endothermic hot gas air-heating mode, the refrigerant mixed at the sixth three-way joint 12f absorbs heat from the low-temperature side heat medium in the chiller 20 to increase enthalpy. The refrigerant flowing out of the fifth three-way joint 12e is heated by the refrigerant electric heater 84 to increase enthalpy when passing through the heating passage 84a.

In the high-temperature side heat medium circuit 30 in the first endothermic hot gas air-heating mode, the high-temperature side heat medium heated by the water-refrigerant heat exchanger 13 flows into the heater core 32 as in the single air-cooling mode.

In the low-temperature side heat medium circuit 40 in the first endothermic hot gas air-heating preparing mode, the low-temperature side heat medium heated when flowing through the cooling water passage 70a of the battery 70 flows into the heat medium passage of the chiller 20.

In the indoor air conditioning unit 50 in the first endothermic hot gas air-heating mode, as in the first embodiment, the ventilation air whose temperature has been adjusted is blown into the vehicle compartment, so that the vehicle compartment is heated.

In the first endothermic hot gas air-heating mode, the heat generated by the heat medium electric heater 44 and the battery 70 as heat generating units can be used to heat ventilation air. Therefore, the vehicle compartment can be heated with a higher heating capability than in the hot gas air-heating mode without increasing the rotation speed of the compressor 11, as in the first embodiment.

(e-2) Second Endothermic Hot Gas Air-Heating Mode

In the heat pump cycle 10 in the second endothermic hot gas air-heating mode, the control device 60 supplies electric power to the refrigerant electric heater 84.

In the low-temperature side heat medium circuit 40a in the second endothermic hot gas air-heating mode, the control device 60 controls the operation of the heat medium three-way valve 42 so as to connect the outlet side of the cooling water passage 70a in the battery 70 and the inlet side of the heat medium bypass passage 45. Therefore, in the low-temperature side heat medium circuit 40a, the low-temperature side heat medium pumped from the low-temperature side pump 41 circulates through the cooling water passage 70a of the battery 70 and the suction port of the low-temperature side pump 41 in this order. Other operations are similar to those of the first embodiment.

In the heat pump cycle 10 in the second endothermic hot gas air-heating mode, the refrigerant flowing out of the fifth three-way joint 12e is heated by the refrigerant electric heater 84 to increase enthalpy when passing through the heating passage 84a.

In the indoor air conditioning unit 50 in the second endothermic hot gas air-heating mode, as in the first embodiment, the ventilation air whose temperature has been adjusted is blown into the vehicle compartment, so that the vehicle compartment is heated.

In the second endothermic hot gas air-heating mode, the heat generated by the heat medium electric heater 44 as the heat generating unit can be used to heat ventilation air. Therefore, the vehicle compartment can be heated with a higher heating capability than in the hot gas air-heating mode without increasing the rotation speed of the compressor 11, as in the first embodiment. In the second endothermic hot gas air-heating mode, the low-temperature side pump 41 may be stopped.

As described above, in the vehicle air conditioner 1a of the present embodiment, comfortable air conditioning in the vehicle compartment and appropriate temperature adjustment of the battery 70, which is an in-vehicle device, can be performed by switching the operation mode.

Since the endothermic hot gas air-heating mode can be performed in the vehicle air conditioner 1a, effects similar to those of the first embodiment can be obtained. That is, in the endothermic hot gas air-heating mode, the ventilation air heating capability can be improved without increasing the rotation speed of the compressor 11, as compared with the hot gas air-heating mode.

### Third Embodiment

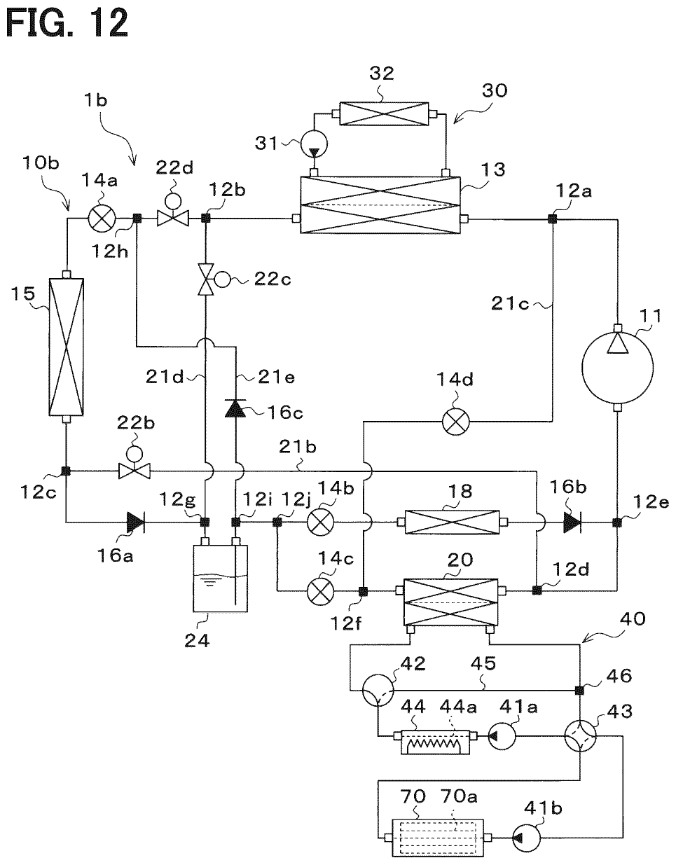

In the present embodiment, the heat pump cycle device according to the present disclosure is applied to a vehicle air conditioner 1b illustrated in the overall configuration diagram of FIG. 12. The vehicle air conditioner 1b is an air conditioner with an in-vehicle device temperature adjustment function similar to that of the first embodiment. The vehicle air conditioner 1b includes a heat pump cycle 10b.

In the heat pump cycle 10b, the accumulator 23 and the like are eliminated from the heat pump cycle 10 described in the first embodiment, and a receiver 24 and the like are used.

In the heat pump cycle 10b, the inlet side of the receiver 24 is connected to the other outflow port of the second three-way joint 12b. The refrigerant passage from the other outflow port of the second three-way joint 12b to an inlet port of the receiver 24 is an inlet side passage 21d. A first inlet side on-off valve 22c and a seventh three-way joint 12g are arranged in the inlet side passage 21d.

The receiver 24 is a high-pressure side gas-liquid separating unit that separates a refrigerant flowing into the receiver into gas and liquid, and stores the separated liquid-phase refrigerant as a surplus refrigerant in the cycle. In the receiver 24, a part of the separated liquid-phase refrigerant flows to the downstream side from a liquid-phase refrigerant outlet port.

The first inlet side on-off valve 22c is an on-off valve that opens and closes the inlet side passage 21d. More specifically, the first inlet side on-off valve 22c opens and closes a refrigerant passage from the other outflow port of the second three-way joint 12b to one inflow port of the seventh three-way joint 12g in the inlet side passage 21d. The first inlet side on-off valve 22c is a refrigerant circuit switching unit.

One inflow port side of an eighth three-way joint 12h is connected to one outflow port of the second three-way joint 12b. A second inlet side on-off valve 22d is disposed in a refrigerant passage from one outflow port of the second three-way joint 12b to one inflow port of the eighth three-way joint 12h. The second inlet side on-off valve 22d opens and closes the refrigerant passage from one outflow port of the second three-way joint 12b to one inflow port of the eighth three-way joint 12h. The second inlet side on-off valve 22d is a refrigerant circuit switching unit.

The other inflow port side of the eighth three-way joint 12h is connected to a liquid-phase refrigerant outlet port of the receiver 24. The refrigerant passage from the outlet port of the receiver 24 to the other inflow port of the eighth three-way joint 12h is an outlet side passage 21e. A ninth three-way joint 12i and a third check valve 16c are arranged in the outlet side passage 21e.

The third check valve 16c allows the refrigerant to flow from the ninth three-way joint 12i side to the eighth three-way joint 12h side, and prohibits the refrigerant from flowing from the eighth three-way joint 12h side to the ninth three-way joint 12i side. The inlet side of the air-heating expansion valve 14a is connected to an outflow port of the eighth three-way joint 12h.

The inflow port side of a tenth three-way joint 12j is connected to the other outflow port of the ninth three-way joint 12i. The refrigerant inlet side of the indoor evaporator 18 is connected to one outflow port of the tenth three-way joint 12j via the air-cooling expansion valve 14b. The other inflow port side of the sixth three-way joint 12f is connected to the other outflow port of the tenth three-way joint 12j via the cooling expansion valve 14c.

Other configurations of the vehicle air conditioner 1b are similar to those of the vehicle air conditioner 1 described in the first embodiment.

Next, the operation of the vehicle air conditioner 1b of the present embodiment with the above configuration will be described. In the vehicle air conditioner 1b, various operation modes are switched as in the vehicle air conditioner 1 described in the first embodiment. Each operation mode will be described below.

(a-1) Single Air-Cooling Mode

In the heat pump cycle 10b in the single air-cooling mode, the control device 60 brings the air-heating expansion valve 14a into a fully open state, brings the air-cooling expansion valve 14b into a throttled state, brings the cooling expansion valve 14c into a fully closed state, and brings the bypass-side flow rate regulating valve 14d into the fully closed state. The control device 60 closes the low-pressure side on-off valve 22b, closes the first inlet side on-off valve 22c, and opens the second inlet side on-off valve 22d.

In the heat pump cycle 10b, the control device 60 controls the operation of the expansion valve in the throttled state such that the superheat degree SH of a suction refrigerant drawn into the compressor 11 is close to a predetermined reference superheat degree KSH (5° C. in the present embodiment).

Therefore, in the heat pump cycle 10b in the single air-cooling mode, the refrigerant circuit is switched to a refrigerant circuit in which the refrigerant discharged from the compressor 11 circulates through the water-refrigerant heat exchanger 13, the air-heating expansion valve 14a in the fully open state, the outdoor heat exchanger 15, the receiver 24, the air-cooling expansion valve 14b, the indoor evaporator 18, and the suction port of the compressor 11 in this order. Other operations are similar to those of the first embodiment.

Therefore, in the heat pump cycle 10b in the single air-cooling mode, a vapor compression refrigeration cycle is configured in which the water-refrigerant heat exchanger 13 and the outdoor heat exchanger 15 function as condensers, and the indoor evaporator 18 functions as an evaporator.

In the high-temperature side heat medium circuit 30 in the single air-cooling mode, as in the first embodiment, the high-temperature side heat medium heated by the water-refrigerant heat exchanger 13 flows into the heater core 32.

In the indoor air conditioning unit 50 in the single air-cooling mode, the conditioned air whose temperature has been adjusted is blown into the vehicle compartment as in the first embodiment. As a result, the vehicle compartment is cooled.

(a-2) Cooling and Air-Cooling Mode

In the heat pump cycle 10b in the cooling and air-cooling mode, the control device 60 brings the cooling expansion valve 14c into the throttled state as compared with the single air-cooling mode. Other operations are similar to those of the first embodiment.

Therefore, in the heat pump cycle 10b in the cooling and air-cooling mode, a vapor compression refrigeration cycle is configured in which the water-refrigerant heat exchanger 13 and the outdoor heat exchanger 15 function as condensers, and the indoor evaporator 18 functions as an evaporator.

In the high-temperature side heat medium circuit 30 in the cooling and air-cooling mode, as in the first embodiment, the high-temperature side heat medium heated by the water-refrigerant heat exchanger 13 flows into the heater core 32.

In the low-temperature side heat medium circuit 40 in the cooling and air-cooling mode, as in the first embodiment, the low-temperature side heat medium cooled by the chiller 20 flows through the cooling water passage 70a of the battery 70. As a result, the battery 70 is cooled.

In the indoor air conditioning unit 50 in the cooling and air-cooling mode, as in the first embodiment, the conditioned air whose temperature has been adjusted is blown into the vehicle compartment. As a result, the vehicle compartment is cooled.

(b-1) Single Dehumidifying and Air-Heating Mode

In the heat pump cycle 10b in the single dehumidifying and air-heating mode, the control device 60 brings the air-heating expansion valve 14a into the throttled state, brings the air-cooling expansion valve 14b into the throttled state, brings the cooling expansion valve 14c into the fully closed state, and brings the bypass-side flow rate regulating valve 14d into the fully closed state. The control device 60 closes the low-pressure side on-off valve 22b, closes the first inlet side on-off valve 22c, and opens the second inlet side on-off valve 22d.

Therefore, in the heat pump cycle 10b in the single dehumidifying and air-heating mode, the refrigerant circuit is switched to a refrigerant circuit in which the refrigerant discharged from the compressor 11 circulates through the water-refrigerant heat exchanger 13, the air-heating expansion valve 14a in the throttled state, the outdoor heat exchanger 15, the receiver 24, the air-cooling expansion valve 14b, the indoor evaporator 18, and the suction port of the compressor 11 in this order. Other operations are similar to those of the first embodiment.

As a result, in the heat pump cycle 10b in the single dehumidifying and air-heating mode, a vapor compression refrigeration cycle is configured in which the water-refrigerant heat exchanger 13 and the outdoor heat exchanger 15 function as condensers, and the indoor evaporator 18 functions as an evaporator.

In the high-temperature side heat medium circuit 30 in the single dehumidifying and air-heating mode, as in the first embodiment, the high-temperature side heat medium heated by the water-refrigerant heat exchanger 13 flows into the heater core 32.

In the indoor air conditioning unit 50 in the single dehumidifying and air-heating mode, the conditioned air whose temperature has been adjusted is blown into the vehicle compartment as in the first embodiment. As a result, the vehicle compartment is dehumidified and heated.

The heat pump cycle 10b includes the receiver 24. Therefore, the dehumidifying and air-heating mode is performed in a temperature range in which the saturation temperature of the refrigerant in the outdoor heat exchanger 15 is higher than the outside air temperature Tam.

(b-2) Cooling and Dehumidifying and Air-Heating Mode

In the heat pump cycle 10b in the cooling and dehumidifying and air-heating mode, the control device 60 brings the cooling expansion valve 14c into the throttled state as compared with the single dehumidifying and air-heating mode. Other operations are similar to those of the first embodiment.

Therefore, in the heat pump cycle 10b in the cooling and dehumidifying and air-heating mode, a vapor compression refrigeration cycle is configured in which the water-refrigerant heat exchanger 13 and the outdoor heat exchanger 15 function as condensers, and the indoor evaporator 18 functions as an evaporator.

In the high-temperature side heat medium circuit 30 in the cooling and dehumidifying and air-heating mode, as in the first embodiment, the high-temperature side heat medium heated by the water-refrigerant heat exchanger 13 flows into the heater core 32.

In the low-temperature side heat medium circuit 40 in the cooling and dehumidifying and air-heating mode, as in the first embodiment, the low-temperature side heat medium cooled by the chiller 20 flows through the cooling water passage 70a of the battery 70. As a result, the battery 70 is cooled.

In the indoor air conditioning unit 50 in the cooling and dehumidifying and air-heating mode, the conditioned air whose temperature has been adjusted is blown into the vehicle compartment as in the first embodiment. As a result, the vehicle compartment is dehumidified and heated.

(c-1) Single Outside Air Endothermic and Air-Heating Mode

In the heat pump cycle 10b in the single outside air endothermic and air-heating mode, the control device 60 brings the air-heating expansion valve 14a into the throttled state, brings the air-cooling expansion valve 14b into the fully closed state, brings the cooling expansion valve 14c into the fully closed state, and brings the bypass-side flow rate regulating valve 14d into the fully closed state. The control device 60 opens the low-pressure side on-off valve 22b, opens the first inlet side on-off valve 22c, and closes the second inlet side on-off valve 22d.

Therefore, in the heat pump cycle 10b in the single outside air endothermic and air-heating mode, the refrigerant circuit is switched to a refrigerant circuit in which the refrigerant discharged from the compressor 11 circulates through the water-refrigerant heat exchanger 13, the inlet side passage 21d, the receiver 24, the outlet side passage 21e, the air-heating expansion valve 14a, the outdoor heat exchanger 15, the low-pressure side passage 21b, and the suction port of the compressor 11 in this order. Other operations are similar to those of the first embodiment.

Therefore, in the heat pump cycle 10b in the single outside air endothermic and air-heating mode, a vapor compression refrigeration cycle is configured in which the water-refrigerant heat exchanger 13 functions as a condenser and the outdoor heat exchanger 15 functions as an evaporator.

In the high-temperature side heat medium circuit 30 in the single outside air endothermic and air-heating mode, as in the first embodiment, the high-temperature side heat medium heated by the water-refrigerant heat exchanger 13 flows into the heater core 32.

In the indoor air conditioning unit 50 in the single outside air endothermic and air-heating mode, the conditioned air whose temperature has been adjusted is blown into the vehicle compartment as in the first embodiment. As a result, the vehicle compartment is heated.

(c-2) Cooling and Outside Air Endothermic and Air-Heating Mode

In the heat pump cycle 10b in the cooling and outside air endothermic and air-heating mode, the control device 60 brings the cooling expansion valve 14c into the throttled state as compared with the single outside air endothermic and air-heating mode. Other operations are similar to those of the first embodiment.

Therefore, in the heat pump cycle 10b in the cooling and outside air endothermic and air-heating mode, a vapor compression refrigeration cycle is configured in which the water-refrigerant heat exchanger 13 functions as a condenser and the outdoor heat exchanger 15 and the chiller 20 function as evaporators.

In the high-temperature side heat medium circuit 30 in the cooling and outside air endothermic and air-heating mode, as in the first embodiment, the high-temperature side heat medium heated by the water-refrigerant heat exchanger 13 flows into the heater core 32.

In the low-temperature side heat medium circuit 40 in the cooling and outside air endothermic and air-heating mode, as in the first embodiment, the low-temperature side heat medium cooled by the chiller 20 flows through the cooling water passage 70a of the battery 70. As a result, the battery 70 is cooled.

In the indoor air conditioning unit 50 in the cooling and outside air endothermic and air-heating mode, the conditioned air whose temperature has been adjusted is blown into the vehicle compartment as in the first embodiment. As a result, the vehicle compartment is heated.

### (d) Hot Gas Air-Heating Mode

In the heat pump cycle 10b in the hot gas air-heating mode, the control device 60 brings the air-heating expansion valve 14a into the fully closed state, brings the air-cooling expansion valve 14b into the fully closed state, brings the cooling expansion valve 14c into the throttled state, and brings the bypass-side flow rate regulating valve 14d into the throttled state. The control device 60 closes the low-pressure side on-off valve 22b, opens the first inlet side on-off valve 22c, and closes the second inlet side on-off valve 22d.

Therefore, in the heat pump cycle 10b in the hot gas air-heating mode, the refrigerant discharged from the compressor 11 circulates through the first three-way joint 12a, the water-refrigerant heat exchanger 13, the inlet side passage 21d, the receiver 24, the cooling expansion valve 14c, the sixth three-way joint 12f, the chiller 20, and the suction port of the compressor 11 in this order. At the same time, the refrigerant circuit is switched to a refrigerant circuit in which the refrigerant discharged from the compressor 11 circulates through the first three-way joint 12a, the bypass-side flow rate regulating valve 14d disposed in the bypass passage 21c, the sixth three-way joint 12f, and the suction port of the compressor 11 in this order. Other operations are similar to those of the first embodiment.

Therefore, in the heat pump cycle 10b in the hot gas air-heating mode, the high-temperature side heat medium is heated by the water-refrigerant heat exchanger 13 as in the first embodiment.

In the high-temperature side heat medium circuit 30 in the hot gas air-heating mode, as in the first embodiment, the high-temperature side heat medium heated by the water-refrigerant heat exchanger 13 flows into the heater core 32.

In the indoor air conditioning unit 50 in the hot gas air-heating mode, as in the first embodiment, the conditioned air whose temperature has been adjusted is blown into the vehicle compartment. As a result, the vehicle compartment is heated.

### (e) Endothermic Hot Gas Air-Heating Mode

In the heat pump cycle 10b in the first endothermic hot gas air-heating mode and the second endothermic hot gas air-heating mode, as in the hot gas air-heating mode, the control device 60 controls the operations of the air-heating expansion valve 14a, the air-cooling expansion valve 14b, the cooling expansion valve 14c, the bypass-side flow rate regulating valve 14d, the low-pressure side on-off valve 22b, the first inlet side on-off valve 22c, and the second inlet side on-off valve 22d. Other operations are similar to those of the first embodiment.

Therefore, in the first endothermic hot gas air-heating mode and the second endothermic hot gas air-heating mode, as in the first embodiment, the vehicle compartment can be heated with a higher heating capability than in the hot gas air-heating mode.

### (f) Endothermic Hot Gas Air-Heating Preparing Mode

In the heat pump cycle 10b in the first endothermic hot gas air-heating preparing mode and the second endothermic hot gas air-heating preparing mode, as in hot gas air-heating mode, the control device 60 controls the operations of the air-heating expansion valve 14a, the air-cooling expansion valve 14b, the cooling expansion valve 14c, the bypass-side flow rate regulating valve 14d, the low-pressure side on-off valve 22b, the first inlet side on-off valve 22c, and the second inlet side on-off valve 22d. Other operations are similar to those of the first embodiment.

Therefore, in the first endothermic hot gas air-heating preparing mode and the second endothermic hot gas air-heating preparing mode, as in the first embodiment, the inflow temperature TWLC of the low-temperature side heat medium can be increased, and air-heating equivalent to that in the hot gas air-heating mode can be continued.

As described above, in the vehicle air conditioner 1b of the present embodiment, comfortable air conditioning in the vehicle compartment and appropriate temperature adjustment of the battery 70, which is an in-vehicle device, can be performed by switching the operation mode.

Since the endothermic hot gas air-heating mode can be performed in the vehicle air conditioner 1b, effects similar to those of the first embodiment can be obtained. That is, in the endothermic hot gas air-heating mode, the ventilation air heating capability can be improved without increasing the rotation speed of the compressor 11, as compared with the hot gas air-heating mode.

### Fourth Embodiment

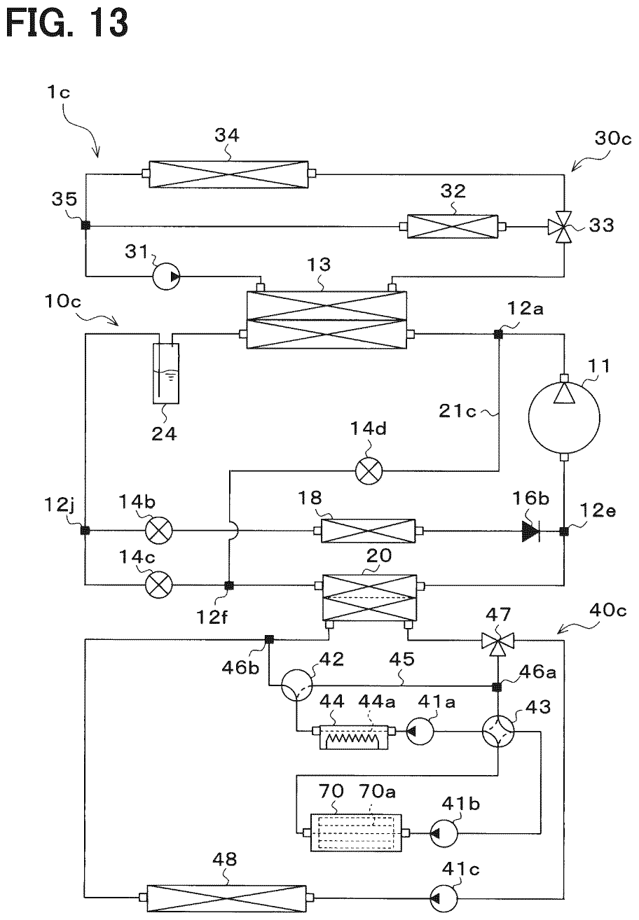

In the present embodiment, the heat pump cycle device according to the present disclosure is applied to a vehicle air conditioner 1c illustrated in the overall configuration diagram of FIG. 13. The vehicle air conditioner 1c is an air conditioner with an in-vehicle device temperature adjustment function similar to that of the first embodiment. The vehicle air conditioner 1c includes a heat pump cycle 10c, a high-temperature side heat medium circuit 30c, and a low-temperature side heat medium circuit 40c.

In the heat pump cycle 10c of the present embodiment, the air-heating expansion valve 14a, the outdoor heat exchanger 15, the low-pressure side passage 21b, the inlet side passage 21d, the outlet side passage 21e, and the like are eliminated from the heat pump cycle 10b described in the third embodiment.

In the heat pump cycle 10c, the inlet side of the receiver 24 is connected to the outlet side of a refrigerant passage in the water-refrigerant heat exchanger 13. The inflow port side of the tenth three-way joint 12j is connected to an outlet port of the receiver 24. Other configurations of the heat pump cycle 10c are similar to those of the heat pump cycle 10b described in the third embodiment.

In the high-temperature side heat medium circuit 30c, a high-temperature side three-way flow rate regulating valve 33 and a high-temperature side radiator 34 are added to the high-temperature side heat medium circuit 30 described in the first embodiment.

The high-temperature side three-way flow rate regulating valve 33 is a three-way flow rate regulating unit capable of continuously regulating the flow rate ratio between the flow rate of a heat medium flowing into the heater core 32 and the flow rate of a heat medium flowing into the high-temperature side radiator 34 in the high-temperature side heat medium flowing out of the heat medium passage of the water-refrigerant heat exchanger 13. The operation of the high-temperature side three-way flow rate regulating valve 33 is controlled by a control signal output from the control device 60.

The high-temperature side three-way flow rate regulating valve 33 can allow the entire flow rate of the high-temperature side heat medium flowing out of the heat medium passage of the water-refrigerant heat exchanger 13 to flow into the heater core 32. The high-temperature side three-way flow rate regulating valve 33 can allow the entire flow rate of the high-temperature side heat medium flowing out of the heat medium passage of the water-refrigerant heat exchanger 13 to flow into the high-temperature side radiator 34.

The high-temperature side radiator 34 is a high-temperature side water-outside air heat exchange unit that exchanges heat between the high-temperature side heat medium flowing out of the high-temperature side three-way flow rate regulating valve 33 and outside air. The high-temperature side radiator 34 is disposed on the front side of a drive unit chamber.

One inflow port side of the high-temperature side heat medium three-way joint 35 is connected to a heat medium outlet port of the high-temperature side radiator 34. In the present embodiment, the other inflow port side of the high-temperature side heat medium three-way joint 35 is connected to a heat medium outlet port of the heater core 32. The suction port side of the high-temperature side pump 31 is connected to an outflow port of the high-temperature side heat medium three-way joint 35.

In the low-temperature side heat medium circuit 40c, a low-temperature side three-way flow rate regulating valve 47, a low-temperature side radiator 48, and a third low-temperature side pump 41c are added to the low-temperature side heat medium circuit 40 described in the first embodiment.

The low-temperature side three-way flow rate regulating valve 47 is a three-way flow rate regulating unit capable of continuously regulating the flow rate ratio between the flow rate of a heat medium flowing into a first low-temperature side heat medium three-way joint 46a and the flow rate of a heat medium drawn into the third low-temperature side pump 41c in the low-temperature side heat medium flowing out of the heat medium passage of the chiller 20. The basic configuration of the low-temperature side three-way flow rate regulating valve 47 is similar to that of the high-temperature side three-way flow rate regulating valve 33. Therefore, the low-temperature side three-way flow rate regulating valve 47 has a function as a heat medium circuit switching unit.

The first low-temperature side heat medium three-way joint 46a is a three-way joint corresponding to the heat medium three-way joint 46 described in the first embodiment. The third low-temperature side pump 41c is a low-temperature side heat medium pumping unit that sucks the low-temperature side heat medium flowing out of the low-temperature side three-way flow rate regulating valve 47 and pumps the low-temperature side heat medium to the heat medium inlet side of the low-temperature side radiator 48. The basic configuration of the third low-temperature side pump 41c is similar to that of the first low-temperature side pump 41a.

The low-temperature side radiator 48 is a low-temperature side water-outside air heat exchange unit that exchanges heat between the low-temperature side heat medium pumped from the third low-temperature side pump 41c and outside air. The low-temperature side radiator 48 is disposed on the front side of the drive unit chamber together with the high-temperature side radiator 34.

One inflow port side of a second low-temperature side heat medium three-way joint 46b is connected to a heat medium outlet port of the low-temperature side radiator 48. In the present embodiment, the other inflow port side of the second low-temperature side heat medium three-way joint 46b is connected to one outflow port of the heat medium three-way valve 42. The inlet side of a heat medium passage in the chiller 20 is connected to an outflow port of the second low-temperature side heat medium three-way joint 46b.

Other configurations of the vehicle air conditioner 1c are similar to those of the vehicle air conditioner 1 described in the first embodiment.

Next, the operation of the vehicle air conditioner 1c of the present embodiment with the above configuration will be described. In the vehicle air conditioner 1c, various operation modes are switched as in the vehicle air conditioner 1 described in the first embodiment. Each operation mode will be described below.

(a-1) Single Air-Cooling Mode

In the heat pump cycle 10c in the single air-cooling mode, the control device 60 brings the air-cooling expansion valve 14b into a throttled state, brings the cooling expansion valve 14c into a fully closed state, and brings the bypass-side flow rate regulating valve 14d into the fully closed state.

In the heat pump cycle 10c, the control device 60 controls the operation of the expansion valve in the throttled state such that the superheat degree SH of a suction refrigerant drawn into the compressor 11 approaches a predetermined reference superheat degree KSH (5° C. in the present embodiment).

Therefore, in the heat pump cycle 10c in the single air-cooling mode, the refrigerant circuit is switched to a refrigerant circuit in which the refrigerant discharged from the compressor 11 circulates through the water-refrigerant heat exchanger 13, the receiver 24, the air-cooling expansion valve 14b, the indoor evaporator 18, and the suction port of the compressor 11 in this order.

In the high-temperature side heat medium circuit 30c in the single air-cooling mode, the control device 60 operates the high-temperature side pump 31 so as to exhibit a predetermined reference pumping capability. The control device 60 controls the operation of the high-temperature side three-way flow rate regulating valve 33 such that the high-temperature side heat medium temperature TWH detected by the high-temperature side heat medium temperature sensor 63a approaches the predetermined reference high-temperature side heat medium temperature KTWH.

In the low-temperature side heat medium circuit 40c in the single air-cooling mode, the control device 60 stops the first low-temperature side pump 41a, the second low-temperature side pump 41b, and the third low-temperature side pump 41c.

In the indoor air conditioning unit 50 in the single air-cooling mode, the control device 60 controls the rotation speed of the indoor blower 52 and the opening of the air mix door 54 as in the first embodiment. In addition, the control device 60 appropriately controls the operations of other control target devices.

Therefore, in the heat pump cycle 10c in the single air-cooling mode, a vapor compression refrigeration cycle is configured in which the water-refrigerant heat exchanger 13 functions as a condenser, and the indoor evaporator 18 functions as an evaporator.

In the high-temperature side heat medium circuit 30 in the single air-cooling mode, the high-temperature side heat medium flowing into the heat medium passage of the water-refrigerant heat exchanger 13 exchanges heat with the refrigerant discharged from the compressor 11 to be heated. The high-temperature side heat medium heated by the water-refrigerant heat exchanger 13 flows into the heater core 32 depending on the opening of the high-temperature side three-way flow rate regulating valve 33.

In the indoor air conditioning unit 50 in the single air-cooling mode, the conditioned air whose temperature has been adjusted is blown into the vehicle compartment as in the first embodiment. As a result, the vehicle compartment is cooled. In the single air-cooling mode of the present embodiment, by increasing the flow rate of the high-temperature side heat medium flowing into the heater core 32 by the high-temperature side three-way flow rate regulating valve 33 of the high-temperature side heat medium circuit 30c as the temperature of the target blowing temperature TAO increases, the vehicle compartment can also be dehumidified and heated.

### (a-2 Cooling and Air-Cooling Mode)

In the heat pump cycle 10c in the cooling and air-cooling mode, the control device 60 brings the cooling expansion valve 14c into the throttled state as compared with the single air-cooling mode. Other configurations of the heat pump cycle 10c are similar to those in the single air-cooling mode.

For this reason, in the heat pump cycle 10c in the cooling and air-cooling mode, the refrigerant discharged from the compressor 11 circulates as in the single air-cooling mode. At the same time, the refrigerant circuit is switched to a refrigerant circuit in which the refrigerant discharged from the compressor 11 circulates through the water-refrigerant heat exchanger 13, the receiver 24, the cooling expansion valve 14c, the chiller 20, and the suction port of the compressor 11 in this order. That is, the refrigerant circuit is switched to a refrigerant circuit in which the indoor evaporator 18 and the chiller 20 are connected in parallel to the refrigerant flow.

In the high-temperature side heat medium circuit 30c in the cooling and air-cooling mode, the control device 60 controls the operations of the high-temperature side pump 31 and the high-temperature side three-way flow rate regulating valve 33 as in the single air-cooling mode.

In the low-temperature side heat medium circuit 40c in the cooling and air-cooling mode, the control device 60 controls the operation of the low-temperature side three-way flow rate regulating valve 47 such that the entire flow rate of the low-temperature side heat medium flowing out of the chiller 20 flows into the first low-temperature side heat medium three-way joint 46a. The control device 60 stops the third low-temperature side pump 41c.

The control device 60 controls the operations of the first low-temperature side pump 41a, the second low-temperature side pump 41b, the heat medium three-way valve 42, and the heat medium four-way valve 43, as in the first embodiment.

In the indoor air conditioning unit 50 in the cooling and air-cooling mode, the control device 60 controls the rotation speed of the indoor blower 52 and the opening of the air mix door 54 as in the first embodiment. In addition, the control device 60 appropriately controls the operations of other control target devices.

Therefore, in the heat pump cycle 10c in the cooling and air-cooling mode, a vapor compression refrigeration cycle is configured in which the water-refrigerant heat exchanger 13 functions as a condenser, and the indoor evaporator 18 and the chiller 20 function as evaporators.

In the high-temperature side heat medium circuit 30c in the cooling and air-cooling mode, the high-temperature side heat medium heated by the water-refrigerant heat exchanger 13 flows into the heater core 32 depending on the opening of the high-temperature side three-way flow rate regulating valve 33, as in the single air-cooling mode.

In the low-temperature side heat medium circuit 40c in the cooling and air-cooling mode, as in the first embodiment, the low-temperature side heat medium cooled by the chiller 20 flows through the cooling water passage 70a of the battery 70. As a result, the battery 70 is cooled.

In the indoor air conditioning unit 50 in the single air-cooling mode, the conditioned air whose temperature has been adjusted is blown into the vehicle compartment as in the first embodiment. As a result, the vehicle compartment is cooled. In the cooling and air-cooling mode of the present embodiment, the vehicle compartment can be dehumidified and heated as in the single air-cooling mode.

(c-1) Single Outside Air Endothermic and Air-Heating Mode

In the heat pump cycle 10c in the single outside air endothermic and air-heating mode, the control device 60 brings the air-cooling expansion valve 14b into the fully closed state, brings the cooling expansion valve 14c into the throttled state, and brings the bypass-side flow rate regulating valve 14d into the fully closed state.

Therefore, in the heat pump cycle 10c in the single outside air endothermic and air-heating mode, the refrigerant circuit is switched to a refrigerant circuit in which the refrigerant discharged from the compressor 11 circulates through the water-refrigerant heat exchanger 13, the receiver 24, the cooling expansion valve 14c, the chiller 20, and the suction port of the compressor 11 in this order.

In the high-temperature side heat medium circuit 30c in the single outside air endothermic and air-heating mode, the control device 60 controls the operations of the high-temperature side pump 31 and the high-temperature side three-way flow rate regulating valve 33 as in the single air-cooling mode.

In the low-temperature side heat medium circuit 40c in the single outside air endothermic and air-heating mode, the control device 60 controls the operation of the low-temperature side three-way flow rate regulating valve 47 such that the entire flow rate of the low-temperature side heat medium flowing out of the chiller 20 flows into the third low-temperature side pump 41c.

The control device 60 stops the first low-temperature side pump 41a and the second low-temperature side pump 41b. The control device 60 operates the third low-temperature side pump 41c so as to exhibit a predetermined reference pumping capability.

In the indoor air conditioning unit 50 in the single outside air endothermic and air-heating mode, the control device 60 controls the rotation speed of the indoor blower 52 and the opening of the air mix door 54 as in the first embodiment. In addition, the control device 60 appropriately controls the operations of other control target devices.

Therefore, in the heat pump cycle 10c in the single outside air endothermic and air-heating mode, a vapor compression refrigeration cycle is configured in which the water-refrigerant heat exchanger 13 functions as a condenser and the chiller 20 functions as an evaporator.

In the high-temperature side heat medium circuit 30c in the single outside air endothermic and air-heating mode, the high-temperature side heat medium heated by the water-refrigerant heat exchanger 13 flows into the heater core 32 depending on the opening of the high-temperature side three-way flow rate regulating valve 33, as in the single air-cooling mode.

In the low-temperature side heat medium circuit 40c in the cooling and air-cooling mode, the low-temperature side heat medium cooled by the chiller 20 is drawn into the third low-temperature side pump 41c via the low-temperature side three-way flow rate regulating valve 47. The low-temperature side heat medium with low temperature pumped from the third low-temperature side pump 41c flows into the low-temperature side radiator 48. The low-temperature side heat medium flowing into the low-temperature side radiator 48 absorbs heat from outside air.

The low-temperature side heat medium whose enthalpy has been increased by the low-temperature side radiator 48 flows into the heat medium passage of the chiller 20. In the chiller 20, the low-pressure refrigerant and the low-temperature side heat medium exchange heat. As a result, the low-pressure refrigerant absorbs the heat of the low-temperature side heat medium (that is, heat absorbed by the low-temperature side heat medium from the outside air).

In the indoor air conditioning unit 50 in the single air-cooling mode, the conditioned air whose temperature has been adjusted is blown into the vehicle compartment as in the first embodiment. As a result, the vehicle compartment is heated.

(c-2) Cooling and Outside Air Endothermic and Air-Heating Mode

In the heat pump cycle 10c in the cooling and outside air endothermic and air-heating mode, the control device 60 brings the air-cooling expansion valve 14b into the fully closed state, brings the cooling expansion valve 14c into the throttled state, and brings the bypass-side flow rate regulating valve 14d into the fully closed state, as in the single outside air endothermic and air-heating mode.

In the high-temperature side heat medium circuit 30c in the cooling and outside air endothermic and air-heating mode, the control device 60 controls the operations of the high-temperature side pump 31 and the high-temperature side three-way flow rate regulating valve 33 as in the single air-cooling mode.

In the low-temperature side heat medium circuit 40c in the cooling and outside air endothermic and air-heating mode, the control device 60 controls the operation of the low-temperature side three-way flow rate regulating valve 47 such that the low-temperature side heat medium flowing out of the chiller 20 flows into both the first low-temperature side heat medium three-way joint 46a and the third low-temperature side pump 41c. The control device 60 operates the third low-temperature side pump 41c so as to exhibit a predetermined reference pumping capability.

The control device 60 controls the operations of the first low-temperature side pump 41a, the second low-temperature side pump 41b, the heat medium three-way valve 42, and the heat medium four-way valve 43, as in the first embodiment.

In the indoor air conditioning unit 50 in the cooling and outside air endothermic and air-heating mode, the control device 60 controls the rotation speed of the indoor blower 52 and the opening of the air mix door 54 as in the first embodiment. In addition, the control device 60 appropriately controls the operations of other control target devices.

Therefore, in the heat pump cycle 10c in the cooling and outside air endothermic and air-heating mode, a vapor compression refrigeration cycle is configured in which the water-refrigerant heat exchanger 13 functions as a condenser and the chiller 20 functions as an evaporator, as in the single outside air endothermic and air-heating mode.

In the high-temperature side heat medium circuit 30c in the cooling and outside air endothermic and air-heating mode, the high-temperature side heat medium heated by the water-refrigerant heat exchanger 13 flows into the heater core 32 depending on the opening of the high-temperature side three-way flow rate regulating valve 33, as in the single air-cooling mode.

In the low-temperature side heat medium circuit 40c in the cooling and outside air endothermic and air-heating mode, the low-temperature side heat medium flowing into the first low-temperature side heat medium three-way joint 46a from the low-temperature side three-way flow rate regulating valve 47 flows through the cooling water passage 70a of the battery 70. As a result, the battery 70 is cooled. The low-temperature side heat medium flowing into the third low-temperature side pump 41c from the low-temperature side three-way flow rate regulating valve 47 absorbs the heat of the outside air in the low-temperature side radiator 48.

In the indoor air conditioning unit 50 in the cooling and outside air endothermic and air-heating mode, the conditioned air whose temperature has been adjusted is blown into the vehicle compartment as in the first embodiment. As a result, the vehicle compartment is heated.

### (d) Hot Gas Air-Heating Mode

In the heat pump cycle 10c in the hot gas air-heating mode, the control device 60 brings the air-cooling expansion valve 14b into the fully closed state, brings the cooling expansion valve 14c into the throttled state, and brings the bypass-side flow rate regulating valve 14d into the throttled state.

Therefore, in the heat pump cycle 10c in the hot gas air-heating mode, the refrigerant discharged from the compressor 11 circulates through the first three-way joint 12a, the water-refrigerant heat exchanger 13, the receiver 24, the cooling expansion valve 14c, the sixth three-way joint 12f, the chiller 20, and the suction port of the compressor 11 in this order. At the same time, the refrigerant circuit is switched to a refrigerant circuit in which the refrigerant discharged from the compressor 11 circulates through the first three-way joint 12a, the bypass-side flow rate regulating valve 14d disposed in the bypass passage 21c, the sixth three-way joint 12f, and the suction port of the compressor 11 in this order.

In the high-temperature side heat medium circuit 30c in the hot gas air-heating mode, the control device 60 controls the operations of the high-temperature side pump 31 and the high-temperature side three-way flow rate regulating valve 33 as in the single air-cooling mode.

In the low-temperature side heat medium circuit 40c in the hot gas air-heating mode, the control device 60 stops the first low-temperature side pump 41a, the second low-temperature side pump 41b, and the third low-temperature side pump 41c as in the single air-cooling mode.

In the indoor air conditioning unit 50 in the hot gas air-heating mode, the control device 60 controls the rotation speed of the indoor blower 52 and the opening of the air mix door 54 as in the first embodiment. In addition, the control device 60 appropriately controls the operations of other control target devices.

Therefore, in the heat pump cycle 10c in the hot gas air-heating mode, the high-temperature side heat medium is heated by the water-refrigerant heat exchanger 13 as in the first embodiment.

In the high-temperature side heat medium circuit 30c in the hot gas air-heating mode, the high-temperature side heat medium heated by the water-refrigerant heat exchanger 13 flows into the heater core 32 depending on the opening of the high-temperature side three-way flow rate regulating valve 33, as in the single air-cooling mode.

In the indoor air conditioning unit 50 in the hot gas air-heating mode, as in the first embodiment, the conditioned air whose temperature has been adjusted is blown into the vehicle compartment. As a result, the vehicle compartment is heated.

### (e) Endothermic Hot Gas Air-Heating Mode

In the heat pump cycle 10c in the first endothermic hot gas air-heating mode and the second endothermic hot gas air-heating mode, as in the hot gas air-heating mode, the control device 60 controls the operations of the air-cooling expansion valve 14b, the cooling expansion valve 14c, and the bypass-side flow rate regulating valve 14d.

In the high-temperature side heat medium circuit 30c in the first endothermic hot gas air-heating mode and the second endothermic hot gas air-heating mode, the control device 60 controls the operations of the high-temperature side pump 31 and the high-temperature side three-way flow rate regulating valve 33 as in the single air-cooling mode.

In the low-temperature side heat medium circuit 40c in the first endothermic hot gas air-heating mode and the second endothermic hot gas air-heating mode, the control device 60 controls the operation of the low-temperature side three-way flow rate regulating valve 47 such that the entire flow rate of the low-temperature side heat medium flowing out of the chiller 20 flows into the first low-temperature side heat medium three-way joint 46a. The control device 60 stops the third low-temperature side pump 41c.

The control device 60 controls the operations of the first low-temperature side pump 41a, the second low-temperature side pump 41b, the heat medium three-way valve 42, and the heat medium four-way valve 43, as in the first embodiment.

Therefore, in the first endothermic hot gas air-heating mode and the second endothermic hot gas air-heating mode, as in the first embodiment, the vehicle compartment can be heated with a higher heating capability than in the hot gas air-heating mode without increasing the rotation speed of the compressor 11.

### (f) Endothermic Hot Gas Air-Heating Preparing Mode

In the heat pump cycle 10c in the first endothermic hot gas air-heating mode and the second endothermic hot gas air-heating mode, as in the hot gas air-heating mode, the control device 60 controls the operations of the air-cooling expansion valve 14b, the cooling expansion valve 14c, and the bypass-side flow rate regulating valve 14d.

In the high-temperature side heat medium circuit 30c in the first endothermic hot gas air-heating mode and the second endothermic hot gas air-heating mode, the control device 60 controls the operations of the high-temperature side pump 31 and the high-temperature side three-way flow rate regulating valve 33 as in the single air-cooling mode.

In the low-temperature side heat medium circuit 40c in the first endothermic hot gas air-heating mode and the second endothermic hot gas air-heating mode, the control device 60 controls the operation of the low-temperature side three-way flow rate regulating valve 47 such that the entire flow rate of the low-temperature side heat medium flowing out of the chiller 20 flows into the first low-temperature side heat medium three-way joint 46a. The control device 60 stops the third low-temperature side pump 41c.

The control device 60 controls the operations of the first low-temperature side pump 41a, the second low-temperature side pump 41b, the heat medium three-way valve 42, and the heat medium four-way valve 43, as in the first embodiment.

Therefore, in the first endothermic hot gas air-heating preparing mode and the second endothermic hot gas air-heating preparing mode, as in the first embodiment, the inflow temperature TWLC of the low-temperature side heat medium can be increased, and air-heating equivalent to that in the hot gas air-heating mode can be continued.

As described above, in the vehicle air conditioner 1c of the present embodiment, comfortable air conditioning in the vehicle compartment and appropriate temperature adjustment of the battery 70, which is an in-vehicle device, can be performed by switching the operation mode.

Since the endothermic hot gas air-heating mode can be performed in the vehicle air conditioner 1c, effects similar to those of the first embodiment can be obtained. In the endothermic hot gas air-heating mode, the ventilation air heating capability can be improved without increasing the rotation speed of the compressor 11, as compared with the hot gas air-heating mode.

The present disclosure is not limited to the embodiments described above, and can be variously modified as follows without departing from the gist of the present disclosure.

The example in which the heat pump cycle device according to the present disclosure is applied to the vehicle air conditioner has been described in the above embodiments, but the application target of the heat pump cycle device is not limited to the vehicle air conditioner. For example, it may be applied to a water heater or the like that heats domestic water as an object to be heated.

The configuration of the heat pump cycle device according to the present disclosure is not limited to the configurations disclosed in the above embodiments.

The example in which the battery 70, which is a temperature adjustment target of the vehicle air conditioner, is used as the low controllable heat generating unit has been described in the above embodiments, but the low controllable heat generating unit is not limited to the battery 70. For example, in a case where the heat pump cycle device is applied to the vehicle air conditioner, a motor generator, an inverter, a PCU, an ADAS control device, and the like, which are objects to be cooled, can be used as low controllable heat generating units.

The motor generator is an electric motor having a function as a motor that outputs traveling drive force and a function as a generator. The inverter supplies electric power to the motor generator or the like. The PCU is a power control unit that performs transformation and power distribution. The ADAS control device is a control device for an advanced driver assistance system.

Furthermore, the battery, the motor generator, the inverter, the PCU, the ADAS, and the like can control the amount of heat generated by inefficiently operating. Therefore, the battery, the motor generator, the inverter, the PCU, the ADAS, and the like can be used as high controllable heat generating units.

The example in which the heat generation amount control unit 60b controls the amount of heat generated by the high controllable heat generating unit has been described in the above embodiments. However, it is needless to mention that the heat generation amount control unit 60b may be capable of controlling the amount of heat generated by both the high controllable heat generating unit and the low controllable heat generating unit.

The example in which the heating unit includes the water-refrigerant heat exchanger 13 and the components of the high-temperature side heat medium circuits 30 and 30c in the heat pump cycles 10 to 10c of the above embodiments has been described, but it is not limited thereto.

For example, an indoor condenser may be used as the heating unit. The indoor condenser is a heating heat exchange unit that exchanges heat between one discharge refrigerant branched at the first three-way joint 12a and ventilation air flowing through the indoor evaporator 18 to heat the ventilation air. The indoor condenser may be disposed in the air passage of the indoor air conditioning unit 50 in the same manner as the heater core 32.

The example in which the sixth three-way joint 12f as the mixing unit is disposed on the refrigerant flow upstream side of the chiller 20 in the heat pump cycles 10 to 10c of the above embodiments has been described, but it is not limited thereto.

For example, the sixth three-way joint may be disposed on the refrigerant flow downstream side of the chiller 20 in the heat pump cycle 10 of the first embodiment. In addition, the sixth three-way joint may be disposed on the downstream side of the heating passage 84a in the refrigerant electric heater 84 in the heat pump cycle 10 of the second embodiment. Even with such a configuration, the heat generated by the refrigerant electric heater 84 can be absorbed by the refrigerant flowing out of the cooling expansion valve 14c in the heating passage 84a.

In the first to fourth embodiments, instead of the sixth three-way joint 12f, a dedicated mixer that homogeneously mixes the refrigerant flowing out of the bypass-side flow rate regulating valve 14d and the refrigerant flowing out of the cooling expansion valve 14c may be disposed. In the first and second embodiments, the sixth three-way joint 12f may be eliminated, and the end of the bypass passage 21c may be directly connected to the accumulator 23.

The example in which the second check valve 16b is used has been described in the above embodiments, but an evaporation pressure regulating valve may be used instead of the second check valve 16b. The evaporation pressure regulating valve is a variable throttle mechanism that maintains a refrigerant evaporating temperature in the indoor evaporator 18 at a predetermined temperature (for example, temperature at which the indoor evaporator 18 can be suppressed) or higher.

As the evaporation pressure regulating valve, a variable throttle mechanism including a mechanical mechanism that increases a valve opening as the pressure of the refrigerant on the refrigerant outlet side of the indoor evaporator 18 increases may be used. As the evaporation pressure regulating valve, a variable throttle mechanism including an electric mechanism similar to that of the air-heating expansion valve 14a or the like may be used.

The control sensor group connected to the input side of the control device 60 is not limited to the detection units disclosed in the above embodiments. Various detection units may be added as necessary.

The example in which R1234yf is used as the refrigerant has been described in the above embodiments, but it is not limited thereto. For example, R134a, R600a, R410A, R404A, R32, R407C, and the like may be used. Alternatively, a mixed refrigerant obtained by mixing a plurality of types of these refrigerants or the like may be used. Furthermore, carbon dioxide may be used as the refrigerant to form a supercritical refrigeration cycle in which the high-pressure side refrigerant pressure is equal to or higher than the critical pressure of the refrigerant.

The example in which PAG oil is used as the refrigerant oil has been described in the above embodiments, but it is not limited thereto. For example, POE (that is, polyolester) or the like may be used.

The example in which an ethylene glycol aqueous solution is used as the low-temperature side heat medium and the high-temperature side heat medium has been described in the above embodiments, but it is not limited thereto. As the high-temperature side heat medium and the low-temperature side heat medium, for example, dimethylpolysiloxane, a solution containing nanofluid or the like, an antifreeze liquid, an aqueous liquid refrigerant containing alcohol or the like, a liquid medium containing oil or the like, and the like may be used.

The control mode of the heat pump cycle device according to the present disclosure is not limited to the control modes disclosed in the above embodiments.

The example in which the upper limit rotation speed determining unit 60e reduces the upper limit rotation speed Nclmt as the vehicle speed Vv decreases has been described in the above embodiments, but it is not limited thereto. For example, the upper limit rotation speed determining unit 60e may further reduce the upper limit rotation speed Nclmt as the rotation speed of the indoor blower 52 decreases within the range of the maximum rotation speed Ncmax or less.

The example in which the rotation speeds of the first low-temperature side pump 41a and the second low-temperature side pump 41b, which are heat medium flow rate regulating units, are increased as the inflow temperature TWLC increases in the endothermic hot gas air-heating mode has been described in the above embodiments, but it is not limited thereto.

For example, instead of the heat medium three-way valve 42, a three-way flow rate regulating valve with a similar configuration to the low-temperature side three-way flow rate regulating valve 47 described in the fourth embodiment may be used to increase the flow rate of the low-temperature side heat medium flowing into the heat medium passage of the chiller 20 as the inflow temperature TWLC increases. In this case, the three-way flow rate regulating valve is the heat medium flow rate regulating unit.

The vehicle air conditioners 1 to 1c capable of performing various operation modes have been described in the above embodiments. However, the heat pump cycle device according to the present disclosure is not necessarily capable of performing all the above operation modes.

The heat pump cycle device according to the present disclosure can obtain the effects described in the above embodiments as long as the endothermic hot gas air-heating mode can be performed. That is, the ventilation air heating capability can be improved without increasing the rotation speed of the compressor 11.

Furthermore, other operation modes may be able to be performed. For example, the hot gas dehumidifying and air-heating mode may be able to be performed in the vehicle air conditioners 1 to 1b of the first to third embodiments. Specifically, in a single hot gas dehumidifying and air-heating mode, the control device 60 causes the refrigerant to circulate as in the hot gas air-heating mode, and at the same time, switches the refrigerant circuit to a refrigerant circuit in which the air-cooling expansion valve 14b is brought into the throttled state and the low-pressure refrigerant flows into the indoor evaporator 18. That is, the refrigerant circuit is switched to a refrigerant circuit in which the indoor evaporator 18 and the chiller 20 are connected in parallel to the refrigerant flow. Therefore, ventilation air can be cooled and dehumidified in the indoor evaporator 18.

In the single hot gas dehumidifying and air-heating mode, the refrigerant with relatively high enthalpy can flow into the sixth three-way joint 12f via the bypass passage 21c. Therefore, even if the refrigerant discharge capability of the compressor 11 is increased, a decrease in the suction refrigerant pressure Ps can be reduced or prevented. As a result, the amount of heat radiated from the discharge refrigerant to the high-temperature side heat medium in the water-refrigerant heat exchanger 13 can be increased without causing frost formation in the indoor evaporator 18.

That is, in the single hot gas dehumidifying and air-heating mode, the vehicle compartment can be dehumidified and heated with a higher heating capability than in the single dehumidifying and air-heating mode. Furthermore, as in the cooling and dehumidifying and air-heating mode of the first to third embodiments, a cooling hot gas dehumidifying and air-heating mode can be performed by controlling the operations of the components in the low-temperature side heat medium circuit 40.

In a case where the heat pump cycles 10 and 10b of the first to third embodiments include the evaporation pressure regulating valve described above, a parallel dehumidifying and air-heating mode may be able to be performed.

Specifically, in a single parallel dehumidifying and air-heating mode, the control device 60 causes the refrigerant to circulate as in the outside air endothermic and air-heating mode, and at the same time, switches the refrigerant circuit to a refrigerant circuit in which the high-pressure side on-off valve 22a is opened, the air-cooling expansion valve 14b is brought into the throttled state, and the low-pressure refrigerant flows into the indoor evaporator 18. That is, the refrigerant circuit is switched to a refrigerant circuit in which the indoor evaporator 18 and the outdoor heat exchanger 15 are connected in parallel to the refrigerant flow. Therefore, ventilation air can be cooled and dehumidified in the indoor evaporator 18.

In the single parallel dehumidifying and air-heating mode, the refrigerant evaporation pressure in the outdoor heat exchanger 15 can be made lower than the refrigerant evaporation pressure in the indoor evaporator 18 by the action of the evaporation pressure regulating valve. As a result, the amount of heat radiated from the discharge refrigerant to the high-temperature side heat medium in the water-refrigerant heat exchanger 13 can be increased without causing frost formation in the indoor evaporator 18.

That is, in the single parallel dehumidifying and air-heating mode, the vehicle compartment can be dehumidified and heated with a higher heating capability than in the single dehumidifying and air-heating mode. Furthermore, the cooling parallel dehumidifying and air-heating mode can be performed by bringing the cooling expansion valve 14c into the throttled state and controlling the operation of each component of the low-temperature side heat medium circuit 40 as in the cooling and dehumidifying and air-heating mode of the first to third embodiments.

A device cooling mode of cooling only the battery 70 without performing air conditioning in the vehicle compartment may be able to be performed. Specifically, when the device cooling mode is performed, the control device 60 switches the refrigerant circuit of the heat pump cycle 10 as in the cooling and air-cooling mode to bring the air-cooling expansion valve 14b into the fully closed state. In addition, the control device 60 may stop the indoor blower 52.

The means disclosed in each of the above embodiments may be appropriately combined within a feasible range. For example, the refrigerant electric heater 84 described in the second embodiment may be used, and the heating passage 84a may be disposed in the heat pump cycles 10 to 10c as in the second embodiment.

The low-temperature side heat medium circuit 40 described in the first embodiment may be applied to the vehicle air conditioner 1a described in the second embodiment. In this case, electric power may be supplied to the heat medium electric heater 44 as in the refrigerant electric heater 84.

The features of the heat pump cycle device described in the embodiment of the present disclosure include at least the following items.

### (Item 1)

A heat pump cycle device includes: a compressor (11) configured to compress and discharge a refrigerant; a branching portion (12a) configured to branch a flow of the refrigerant discharged from the compressor; a heating unit (13, 30, 30c) configured to heat an object to be heated using the refrigerant flowing out of one outflow port of the branching portion as a heat source; a heating-unit side decompression unit (14c) configured to decompress the refrigerant flowing out of the heating unit; a bypass passage (21c) through which an another refrigerant branched at the branching portion flows; a bypass-side flow rate regulating unit (14d) configured to regulate a flow rate of the refrigerant flowing through the bypass passage; a joining portion (12f) configured to join a flow of the refrigerant flowing out of the bypass-side flow rate regulating unit and a flow of the refrigerant flowing out of the heating-unit side decompression unit, and to cause a joined flow of the refrigerant to flow into a suction port side of the compressor; a heat generating unit (44, 70, 84) configured to generate heat; and an endothermic unit (20, 84a) configured to cause at least the refrigerant flowing out of the heating-unit side decompression unit to absorb heat generated by the heat generating unit (44, 70, 84).

### (Item 2)

The heat pump cycle device according to item 1 further includes a heat medium circuit (40, 40c) in which a heat medium heated by the heat generating unit circulates. In addition, the endothermic unit is a heat exchanger that exchanges heat between the heat medium and the refrigerant, and the heat medium circuit is configured to cause the heat medium to flow into the endothermic unit when an inflow temperature (TWLC) of the heat medium flowing into the endothermic unit is equal to or higher than a target heat medium temperature (TWLCO).

### (Item 3)

The heat pump cycle device according to item 2, further includes a heat generation amount control unit (60b) configured to control an amount of heat generated by the heat generating unit. In addition, the heat generation amount control unit controls the amount of heat generated by the heat generating unit such that the inflow temperature (TWLC) is equal to or higher than the target heat medium temperature (TWLCO).

### (Item 4)

In the heat pump cycle device according to item 3, the heat medium circuit includes a heat medium circuit switching unit (42, 43, 47) configured to switch a circuit configuration of the heat medium circuit, and a heat medium bypass passage (45) through which the heat medium heated by the heat generating unit flows while bypassing the endothermic unit. In addition, the heat medium circuit switching unit switches to a circuit in which the heat medium heated by the heat generating unit flows into the heat medium bypass passage when the inflow temperature (TWLC) is lower than the target heat medium temperature (TWLCO).

### (Item 5)

In the heat pump cycle device according to item 3 or 4, the heat medium circuit includes a heat medium circuit switching unit (42, 43, 47) configured to switch a circuit configuration of the heat medium circuit, the heat generating unit includes a high controllable heat generating unit (44) and a low controllable heat generating unit (70), the low controllable heat generating unit has a controllable heat amount lower than that generated from the high controllable heat generating unit, and the heat medium circuit switching unit switches to a circuit in which the heat medium flowing out of the low controllable heat generating unit is heated by the high controllable heat generating unit and the heat medium heated by the high controllable heat generating unit flows into the endothermic unit when the inflow temperature (TWLC) is equal to or higher than the target heat medium temperature (TWLCO).

### (Item 6)

In the heat pump cycle device according to any one of items 2 to 5, the heat medium circuit includes a heat medium flow rate regulating unit (41a, 41b) that is configured to regulate an inflow rate of the heat medium flowing into the endothermic unit, and the heat medium flow rate regulating unit increases the inflow rate as the inflow temperature (TWLC) increases.

### (Item 7)

In the heat pump cycle device according to any one of items 1 to 6, further includes: an upper limit rotation speed determining unit (60e) configured to determine an upper limit rotation speed (Nclmt) of the compressor; and a heat generation amount control unit (60b) configured to control an amount of heat generated by the heat generating unit. In addition, the heat generation amount control unit controls an operation of the heat generating unit such that a total amount of heat generated by the heat generating unit increases as the upper limit rotation speed (Nclmt) decreases.

The present disclosure has been described in accordance with examples, but it is understood that the present disclosure is not limited to the examples and structures. The present disclosure also includes various modifications and modifications within an equivalent range. In addition, various combinations and modes, and other combinations and modes including only one element, more elements, or less elements are also within the scope and idea of the present disclosure.

What is claimed is:

1. A heat pump cycle device comprising:
a compressor configured to compress and discharge a refrigerant;
a branching portion configured to branch a flow of the refrigerant discharged from the compressor;
a heating unit configured to heat an object to be heated using the refrigerant flowing out of one outflow port of the branching portion as a heat source;
a first decompression valve configured to decompress the refrigerant flowing out of the heating unit;
a bypass passage through which an another refrigerant branched at the branching portion flows;
a second decompression valve configured to decompress and regulate a flow rate of the refrigerant flowing through the bypass passage;
a joining portion configured to join a flow of the refrigerant flowing out of the second decompression valve and a flow of the refrigerant flowing out of the first decompression valve, and to cause a joined flow of the refrigerant to flow into a suction port side of the compressor;
a heat generating unit configured to generate heat;
a heat medium circuit in which a heat medium heated by the heat generating unit circulates; and
a heat exchanger that exchanges heat between the heat medium and the refrigerant to cause at least the refrigerant flowing out of the first decompression valve to absorb heat generated by the heat generating unit, wherein
the heat medium circuit is configured to cause the heat medium to flow into the heat exchanger when an inflow temperature of the heat medium flowing into the heat exchanger is equal to or higher than a target heat medium temperature.

2. The heat pump cycle device according to claim 1, further comprising
a controller configured to control an amount of heat generated by the heat generating unit, wherein
the controller controls the amount of heat generated by the heat generating unit to cause the inflow temperature to be equal to or higher than the target heat medium temperature.

3. The heat pump cycle device according to claim 2, wherein
the heat medium circuit includes a heat medium circuit switching unit configured to switch a circuit configuration of the heat medium circuit, and a heat medium bypass passage through which the heat medium heated by the heat generating unit flows while bypassing the heat exchanger, and
the heat medium circuit switching unit switches to a circuit in which the heat medium heated by the heat generating unit flows into the heat medium bypass passage when the inflow temperature is lower than the target heat medium temperature.

4. The heat pump cycle device according to claim 2, wherein
the heat medium circuit includes a heat medium circuit switching unit configured to switch a circuit configuration of the heat medium circuit,
the heat generating unit includes a first generating unit, and a second generating unit having a controllable heat amount lower than that generated from the first heat generating unit, and
the heat medium circuit switching unit switches to a circuit in which the heat medium flowing out of the second heat generating unit is heated by the first heat generating unit and the heat medium heated by the first heat generating unit flows into the heat exchanger when the inflow temperature is equal to or higher than the target heat medium temperature.

5. The heat pump cycle device according to claim 1, wherein
the heat medium circuit includes a flow rate regulating valve that is configured to regulate an inflow rate of the heat medium flowing into the heat exchanger, and
the flow rate regulating valve increases the inflow rate of the heat medium flowing into the heat exchanger as the inflow temperature increases.

6. The heat pump cycle device according to claim 1, wherein
the controller is configured to determine an upper limit rotation speed of the compressor, and to control an amount of heat generated by the heat generating unit, and
the controller controls an operation of the heat generating unit such that a total amount of heat generated by the heat generating unit increases as the upper limit rotation speed decreases.

7. A heat pump cycle device comprising:
a compressor configured to compress and discharge a refrigerant;
a branching portion configured to branch a flow of the refrigerant discharged from the compressor;
a heating unit configured to heat an object to be heated using the refrigerant flowing out of one outflow port of the branching portion as a heat source;
a first decompression valve configured to decompress the refrigerant flowing out of the heating unit;
a bypass passage through which an another refrigerant branched at the branching portion flows;
a second decompression valve configured to decompress and regulate a flow rate of the refrigerant flowing through the bypass passage;
a joining portion configured to join a flow of the refrigerant flowing out of the second decompression valve and a flow of the refrigerant flowing out of the first decompression valve, and to cause a joined flow of the refrigerant to flow into a suction port side of the compressor;
a heat generating unit configured to generate heat;
a heat exchanger configured to cause at least the refrigerant flowing out of the first decompression unit to absorb heat generated by the heat generating unit; and
a controller including at least one of a circuit and a processor having a memory storing computer program code, wherein
the at least one of the circuit and the processor having the memory is configured to:
determine an upper limit rotation speed of the compressor; and
control an amount of heat generated by the heat generating unit to cause a total amount of heat generated by the heat generating unit to be increased as the upper limit rotation speed decreases.
